(19) United States
(12) Patent Application Publication
(10) Pub. No.: US 2025/0167964 A1
(43) Pub. Date: May 22, 2025

(54) COMMUNICATION APPARATUS AND COMMUNICATION METHOD FOR SUBCARRIER SELECTIVE FEEDBACK

(71) Applicant: Panasonic Intellectual Property Corporation of America, Torrance, CA (US)

(72) Inventors: Rojan CHITRAKAR, Singapore (SG); Yoshio URABE, Nara (JP); Hiroyuki MOTOZUKA, Kanagawa (JP)

(21) Appl. No.: 18/841,625

(22) PCT Filed: Feb. 15, 2023
(86) PCT No.: PCT/SG2023/050087

§ 371 Date: Aug. 26, 2024

(30) Foreign Application Priority Data
Mar. 2, 2022 (SG) 10202202082T

(51) Int. Cl. H04L 5/00; H04L 1/00; H04L 1/1607

(52) U.S. Cl. CPC H04L 5/0057; H04L 1/0068; H04L 1/1614; H04L 5/0098

(57) ABSTRACT

Communication devices and methods for subcarrier selective feedback are provided. One exemplary embodiment provides a first communication apparatus comprising: a receiver, which in operation, receives a PPDU; circuitry, which in operation, measures channel information of a channel based on the PPDU, wherein the channel to be measured is sub-divided into two or more segments and each of the two or more segments comprises one or more subcarriers, and selects a subset of one or more subcarriers to be reported for the corresponding segment; and a transmitter, which in operation, transmits a report frame carrying channel information feedback based on the channel information for the selected subcarriers to a second communication apparatus.

### BACKGROUND

### 1. Technical Field

The present embodiments generally relate to communication apparatuses, and more particularly relate to methods and apparatuses for subcarrier selective feedback.

### 2. Description of the Related Art

In the standardization of next generation wireless local area network (WLAN), new technology to enable wireless sensing utilizing IEEE 802.11 technologies has been discussed in the 802.11 Working Group and is named 802.11bf WLAN SENS (referred to as 11bf subsequently).

In explicit feedback beamforming, channel sounding and the corresponding feedback is used to help a beamformer decide the steering matrix, Q, to be used for beamformed transmissions. IEEE 802.11 defines three types of channel sounding feedback, namely channel state information (CSI) matrices feedback (as described in 11n, wherein a beamformer receives a quantized MIMO channel matrix, Heff, from a beamformee), non-compressed beamforming feedback matrix (as described in 11n, wherein beamforming feedback matrices, V, found by a beamformee are sent to a beamformer), and compressed beamforming feedback matrix (as described in 11n, 11ac and 11ax, wherein beamforming feedback matrices, V, found by a beamformee are compressed in the form of angles (Ψ (Psi) and (Φ (Phi)), which are sent to a beamformer).

In 802.11bf, it is agreed that CSI (that is, the channel measured during the training symbols of a received PPDU) is a type of sensing measurement result for sub-7 GHz WLAN sensing. To enable sub-7 GHz WLAN sensing, an RXVECTOR parameter CSI_ESTIMATE is defined that contains the channel measured during the training symbols of the received PPDU. The format of CSI_ESTIMATE may be the same one used in a measurement report field within a Sensing Measurement Report frame. A Sensing Measurement Report frame, which allows a sensing receiver to report sensing measurements, is also defined. This frame contains at least a measurement report control field which contains information necessary to interpret the measurement report field, or a measurement report field which carries CSI measurements obtained by a sensing receiver.

As can be seen from table 100 of FIG. 1A (i.e. depicting Table 9-56—CSI Report field (20 MHz) in IEEE P802.11-2020), the CSI Report format used in 802.11n to carry CSI feedback is such that the CSI matrix for each reported subcarrier requires (3+2*Nb*Nc*Nr) bits. 3 bits/carrier is for Carrier Matrix Amplitude (or the scaling ratio per subcarrier M_{H}(k)), and there is one I and one Q value per subcarrier. Table 102 of FIG. 1B illustrates the meaning and range of values for each CSI field parameter, in particular that Nb refers to number of bits used to quantize I and Q as determined by the Coefficient Size field of the MIMO Control field, Nc refers to number of columns in a CSI matrix, Nr refers to number of rows in a CSI matrix and Ng refers to a subcarrier grouping parameter.

The size of the CSI feedback may be reduced by using subcarrier grouping. Grouping is a method that reduces the size of the CSI Report field by reporting a single value for each group of Ng adjacent subcarriers. With grouping, the size of the CSI Report field is Nr*8+Ns*(3+2*Nb*Nc*Nr) bits, where the number of subcarriers sent, Ns, is a function of Ng and the bandwidth. Subcarrier indices scidx(i), i=0, . . . , Ns−1 are the subset of the subcarrier indices identified by the bandwidth (BW) and Grouping subfields for 802.11ax, as defined in table 200 of FIG. 2 (i.e. depicting Table 9-91e of IEEE P802.11-2020), starting with scidx(0) and ending with scidx(Ns−1), in the order given. This implicitly defines Ns. For full-bandwidth feedback, subcarrier indices scidx(i), i=0, . . . , Ns−1 are the entire superset shown in table 200, in the order given.

802.11ax and 802.11be (baseline for sub-7 GHz 11bf) only supports Ng=4 and 16, and the indices of the reported subcarrier are fixed by the standard. Assuming 11 bf adopts the same Ng values, if a high value is chosen, the CSI feedback will omit many subcarriers, while if a low value is chosen, the CSI feedback overhead will be large.

There is thus a need for communication apparatuses and methods that can solve the above-mentioned issue. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and communication methods for reduced dimension CSI feedback.

According to an aspect of the present disclosure, there is provided a first communication apparatus comprising: a receiver, which in operation, receives a physical layer protocol data unit (PPDU); circuitry, which in operation, measures channel information of a channel based on the PPDU, wherein the channel to be measured is sub-divided into two or more segments and each of the two or more segments comprises one or more subcarriers, and selects a subset of one or more subcarriers to be reported for the corresponding segment; and a transmitter, which in operation, transmits a report frame carrying channel information feedback based on the channel information for the selected subcarriers to a second communication apparatus.

According to another aspect of the present disclosure, there is provided a second communication apparatus, comprising: a transmitter, which in operation, transmits a PPDU that is used to measure channel information of a channel by the first communication apparatus, wherein the channel to be measured is sub-divided into two or more segments and each of the two or more segments comprises one or more subcarriers, and wherein a subset of subcarriers to be reported for the corresponding segment is selected based on a grouping parameter Ng; and a receiver, which in operation, receives a report frame from the first communication apparatus, the report frame carrying channel information feedback based on the channel information for the selected subcarriers.

According to another aspect of the present disclosure, there is provided a communication method comprising: receiving a physical layer protocol data unit (PPDU); measuring channel information of a channel based on the PPDU, wherein the channel to be measured is sub-divided into two or more segments and each of the two or more segments comprises one or more subcarriers; selecting a subset of one or more subcarriers to be reported for the corresponding segment; and transmitting a report frame carrying channel information feedback based on the channel information for the selected subcarriers.

It should be noted that general or specific embodiments may be implemented as a system, a method, an integrated circuit, a computer program, a storage medium, or any selective combination thereof. Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

The accompanying figures where like reference numerals refer to identical or functionally similar elements throughout the separate views and which together with the detailed description below are incorporated in and form part of the specification, serve to illustrate various embodiments and to explain various principles and advantages in accordance with present embodiments.

FIG. 1A depicts a table for 20 MHz CSI Report field according to an example.

FIG. 1B depicts a table for CSI field parameters according to an example.

FIG. 2 depicts a table describing subcarrier indices for compressed beamforming feedback matrix according to an example.

FIG. 3 depicts an example illustration of an Extremely High Throughput (EHT) null data packet announcement (NDPA) frame.

FIG. 4 depicts an example table describing how the Ng value is signaled in a STA Info field in an EHT NDPA frame.

FIG. 5 depicts example graphs describing CSI time series patterns and variance of subcarriers for vital sign sensing applications (from ‘Tracking vital signs during sleep leveraging off-the-shelf WiFi,’ (J. Liu, Y. Wang, Y. Chen, J. Yang, X. Chen, and J. Cheng, 2015)).

FIGS. 6A, 6B and 6C depict example graphs describing CSI measurements across subcarriers, corresponding score across the subcarriers, and respiration analysis based on a selected subcarrier, respectively (from ‘Continuous user verification via respiratory biometrics’ (Liu, J., Chen, Y., Dong, Y., Wang, Y., Zhao, T. and Yao, Y. D., 2020)).

FIGS. 7A, 7B and 7C depict example graphs for vital sign sensing describing CSI phase difference patterns after data calibration, mean absolute deviation of each subcarrier, and heart rate estimation based on fast fourier transform (FFT), respectively (from ‘PhaseBeat: Exploiting CSI Phase Data for Vital Sign Monitoring with Commodity WiFi Devices,’ (Xuyu Wang, Chao Yang, and Shiwen Mao. 2017)).

FIG. 8 depicts an example graph describing cluster of phase difference for human motion sensing (from ‘Light Weight Passive Human Motion Detection with WiFi’, (Xu Wang, Linghua Zhang. 2021)).

FIG. 9 depicts an example illustration of subcarrier reporting according to an example.

FIG. 10 depicts an example table describing subcarrier indices for CSI, amplitude and phase matrices according to an example.

FIG. 11 depicts an example illustration of subcarrier selective feedback according to an example.

FIGS. 12A and 12B depict, respectively, example flowcharts of an initiator station (STA) procedure and a responder STA procedure according to an example.

FIG. 13 depicts an example illustration of subcarrier selection and sensing according to an embodiment E1.

FIG. 14 depicts an example illustration of a Sensing NDPA frame according to an embodiment E1.

FIGS. 15A and 15B depict, respectively, example tables showing various values for resource unit (RU) size field and Ng_exponent field according to an embodiment E1.

FIG. 16 depicts an example illustration of a sensing measurement report frame according to an embodiment E1.

FIG. 17 depicts an example table describing a sensing measurement report field for CSI according to an embodiment E1.

FIG. 18 depicts an example table describing values of scidx_mth_segment(k) when the segment sizes are 242 tones or 484 tones according to an embodiment E1.

FIG. 19 depicts an example table describing values of scidx_mth_segment(k) when the segment sizes are 996 tones or 2*996 tones according to an embodiment E1.

FIGS. 20A and 20B depict, respectively, an example illustration of a sensing NDPA frame and an example illustration of reported subcarriers based on a bandwidth of 160 MHz according to an embodiment E1.

FIGS. 21A and 21B depict, respectively, an example illustration of a sensing NDPA frame and an example illustration of reported subcarriers based on a bandwidth of 320 MHz according to an embodiment E1.

FIG. 22 shows an example illustration of a sensing session setup request frame according to an embodiment E1.

FIG. 23 depicts an example illustration of a sensing measurement setup request frame according to an embodiment E1.

FIG. 24 depicts an example illustration of a respiration estimation sensing application setup according to an embodiment E1.

FIG. 25 depicts an example illustration of a coarse grain CSI feedback sensing procedure according to an embodiment E1.

FIG. 26 depicts example illustrations of CSI amplitude curves of a selected subcarrier for respiration estimation sensing application according to an embodiment E1.

FIG. 27A depicts an example illustration of fine grain CSI feedback collection for detecting number of individuals and identifying subcarriers for respiration estimation according to an embodiment E1.

FIG. 27B depicts an example illustration of fine grain CSI feedback collection over subchannels containing subcarriers of interest for respiration estimation according to an embodiment E1.

FIG. 28 shows an example flowchart for respiration estimation sensing process according to an embodiment E1.

FIGS. 29A and 29B depict, respectively, an example illustration of a sensing NDPA frame and a sensing measurement report frame according to an embodiment E2.

FIGS. 30A and 30B depict example illustrations of a partial BW Info subfield for when bit B0 is set to ‘0’ and ‘1’ respectively according to an embodiment E3.

FIG. 31 shows a table describing additional settings for BW, Partial BW Info subfield in a sensing NDPA frame in addition to the settings already allowed in an EHT NDPA frame according to an embodiment E3.

FIG. 32 depicts an example illustration of a sensing NDPA frame according to an embodiment E3.

FIG. 33 depicts an example illustration of a sensing measurement report field and corresponding feedback process according to an embodiment E3.

FIG. 34 depicts another example illustration of a sensing measurement report field and corresponding feedback process according to an embodiment E3.

FIG. 35 depicts an example illustration of a sensing NDPA frame according to an embodiment E4.

FIG. 36 depicts an example illustration of a sensing NDPA frame and corresponding feedback process according to an embodiment E4.

FIG. 37 depicts an example illustration of subcarriers according to an embodiment E5.

FIG. 38 depicts an example table showing reported subcarriers for feedback on a 996-tone RU (in 80 MHz) for two values of subcarrier_offset (2, 8) according to an embodiment E5.

FIGS. 39A and 39B depict, respectively, an example illustration of a sensing NDPA frame and a sensing measurement report frame according to an embodiment E5.

FIGS. 40A and 40B depict, respectively, another example illustration of a sensing NDPA frame and a sensing measurement report frame according to an embodiment E5.

FIG. 41 depicts an example illustration of beamforming feedback according to an embodiment E6.

FIGS. 42A and 42B depict, respectively, an example illustration of a sensing NDPA frame and an EHT compressed beamforming or channel quality information (CQI) frame according to an embodiment E6.

FIGS. 43A and 43B depict, respectively, an example illustration of a sensing NDPA frame and a sensing measurement report frame according to an embodiment E7.

FIG. 44 depicts an example table showing example encoding for subcarrier selection condition field (2 bits) according to an embodiment E7.

FIG. 45 depicts an example illustration of a sensing NDPA frame and corresponding encoding for Ng component field according to an embodiment E7-1.

FIG. 46 depicts an example table describing sensing measurement report field for CSI feedback according to an embodiment E7-1.

FIG. 47 depicts an example illustration of a sensing measurement report field and corresponding feedback process according to an embodiment E7-1.

FIG. 48 depicts a schematic diagram for an apparatus suitable for sensing and communication in accordance with various embodiments.

FIG. 49 depicts a schematic diagram for a sensing apparatus in accordance with various embodiments.

FIG. 50 shows a flow diagram illustrating a method for subcarrier selective feedback according to various embodiments.

FIG. 51 shows a schematic, partially sectioned view of a STA that can be implemented for subcarrier selective feedback in accordance with various embodiments.

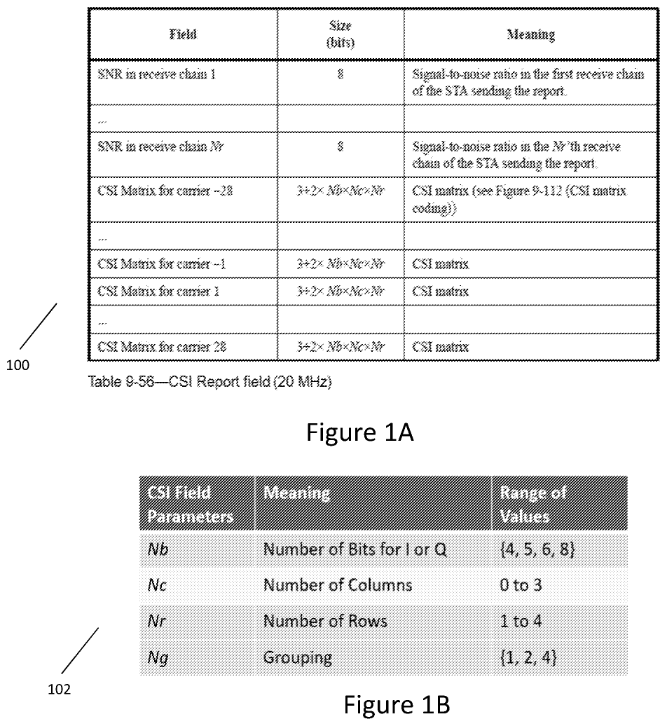

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the embodiments or the application and uses of the embodiments. Furthermore, there is no intention to be bound by any theory presented in the preceding Background or this Detailed Description. Furthermore, other desirable features and characteristics will become apparent from the subsequent detailed description and the appended claims, taken in conjunction with the accompanying drawings and this background of the disclosure.

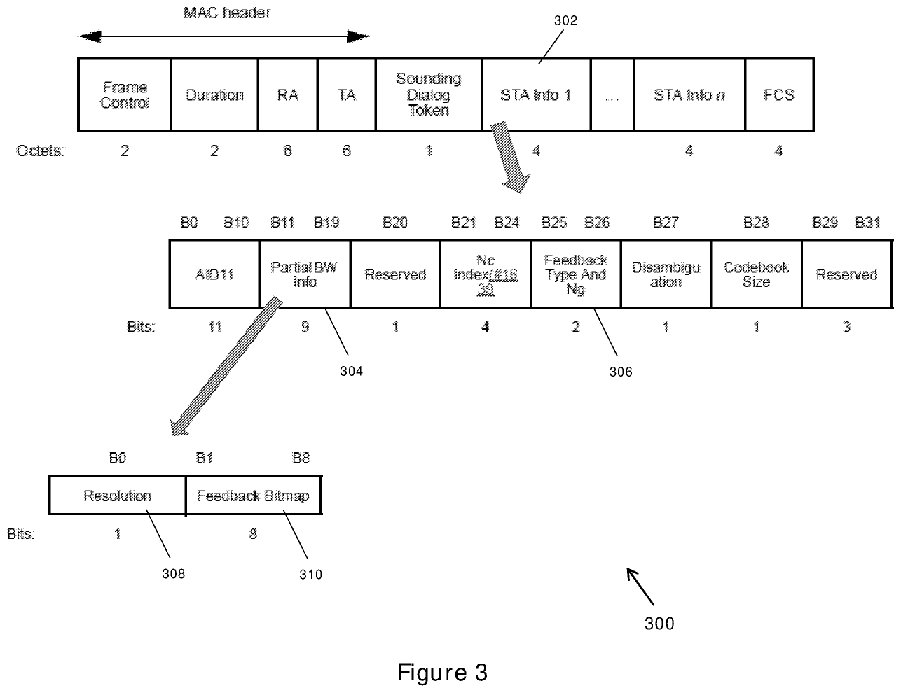

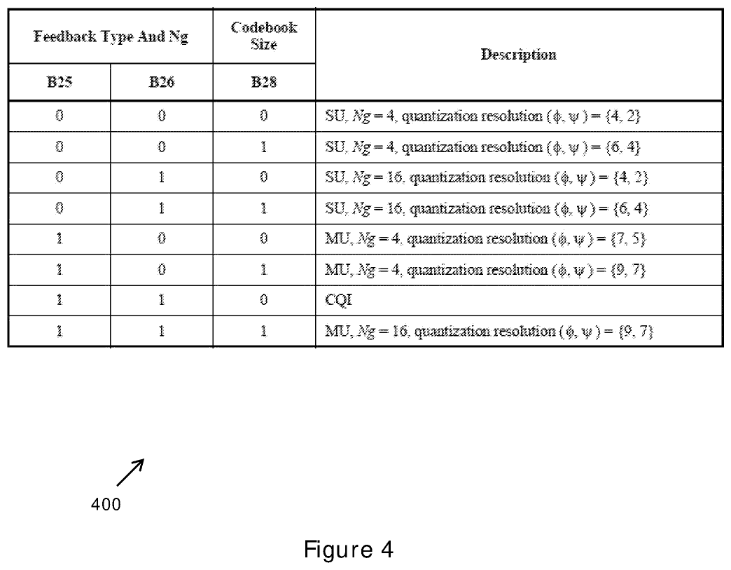

In an EHT non-TB sounding sequence where the STA Info field in the EHT NDP Announcement frame solicits SU (Single-User) feedback, the subcarrier grouping, Ng, codebook size and the number of columns, Nc, used for the generation of the SU feedback are determined by the EHT beamformee regardless of the parameters indicated by the EHT beamformer. However, for MU (Multi-User) feedback, the subcarrier grouping, Ng, codebook size and the number of columns, Nc, used for the generation of the MU feedback are determined by the EHT beamformer and indicated in the EHT NDP Announcement frame. For example, referring to EHT NDPA frame 300 of FIG. 3, grouping parameter Ng may be indicated in feedback type and Ng subfield 306 of a STA Info field 302. An example of values and corresponding descriptions that may be indicated in the feedback type and Ng subfield 306 is shown in table 400 of FIG. 4.

Further, the EHT NDPA frame 300 may comprise a partial BW Info subfield 304 in the STA Info field 302, which further comprises a resolution subfield 308 and a feedback bitmap subfield 310. For a BW of 320 MHz, a value of 0 in the resolution subfield 308 indicates 20 MHz and a value of 1 indicates a resolution of 40 MHz. The feedback bitmap subfield 310 indicates each resolution bandwidth that the beamformer is requesting feedback. Each bit in the feedback bitmap subfield 310 is set to 1 if feedback on the corresponding bandwidth is requested, and is set to 0 otherwise. It is used to select the resource unit/multi-resource unit (RU/MRU) for which feedback is solicited.

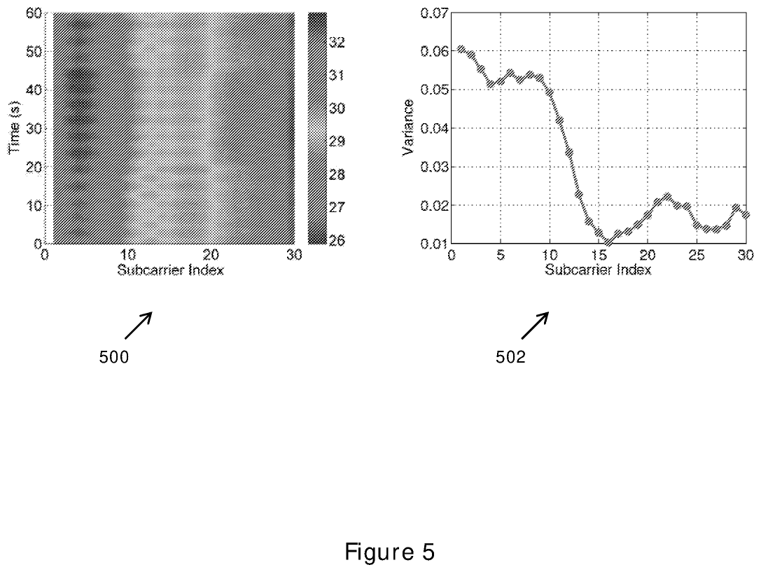

In mainstream 802.11, the sounding procedure is used by the Beamformer to collect the channel information in order to perform accurate estimation of transmit beamforming and it can be argued that the channel information feedback (e.g., compressed beamforming feedback) is not required for each subcarrier within the channel bandwidth and hence the use of large Ng values (4 and 16) in the new 802.11 amendments (802.11ax, 802.11be). The channel information of subcarriers that are not reported may be estimated by the Beamformer using techniques such as interpolation etc. However, in sounding used for Sensing applications, the channel information feedback may be more sensitive to the subcarrier frequencies. As an example, one popular sensing application is human vital signs detection using CSI of WLAN signals. CSI is represented as a complex number, which can be broken down into amplitude and phase components. The importance of subcarrier selection for sensing applications such as vital sign detection has been well documented in literatures. For example, ‘Tracking vital signs during sleep leveraging off-the-shelf WiFi,’ (J. Liu, Y. Wang, Y. Chen, J. Yang, X. Chen, and J. Cheng, 2015) shows that the amplitudes of different subcarriers have different sensitivity to inhaling and exhaling caused by breathing due to frequency diversity. Illustration 500 of FIG. 5 presents an example of CSI amplitude over time on 30 subcarriers extracted from a laptop in Wi-Fi network when a person is asleep. We find that the CSI from the smaller subcarrier indices is significantly affected by the minute movements caused by breathing, while CSI from the higher subcarrier indices (i.e., from 15 to 30) is less sensitive. We may also utilize the variance of CSI amplitude in a moving time window to quantify the subcarrier's sensitivity to minute movements. Illustration 502 of FIG. 5 shows the variance of 30 subcarriers. We can see that subcarriers with lower indices have higher variance, which indicate that they are more sensitive to minute movements. A threshold-based method may be used to select subcarriers having large variance of CSI amplitude in a time window for breathing rate estimation. In this disclosure, such subcarriers may be called “subcarriers of interest”.

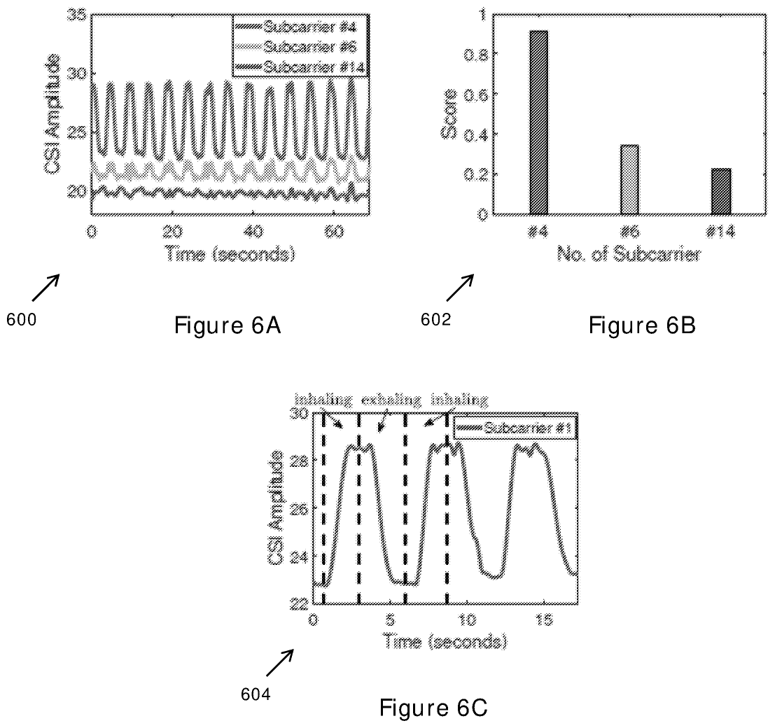

‘Continuous user verification via respiratory biometrics’ (Liu, J., Chen, Y., Dong, Y., Wang, Y., Zhao, T. and Yao, Y. D., 2020) has shown that further, even within a group of sensitive subcarriers, because each subcarrier experiences unique multipath and shadowing effects, CSI of different subcarriers have different sensitivities to subtle respiratory motions. The more sensitive the subcarrier is to respiratory motions, the more comprehensive characteristics of respiratory motions can be captured by CSI. As an example, illustration 600 of FIG. 6A depicts the extracted respiration signals from three subcarriers (i.e., subcarriers #4, #6, and #14). It can be observed that the signal of subcarrier #4 has the greater periodicity and higher amplitude of fluctuation than other two subcarriers, which corresponds to the top score shown in illustration 602 of FIG. 6B. Measurement periodicity is important to ensure sufficient sampling rate. Furthermore, as can be seen in illustration 604 of FIG. 6C, selected sensitive subcarriers may be subsequently used to derive respiration analysis based on inhaling and exhaling detection (breathing rate, etc.).

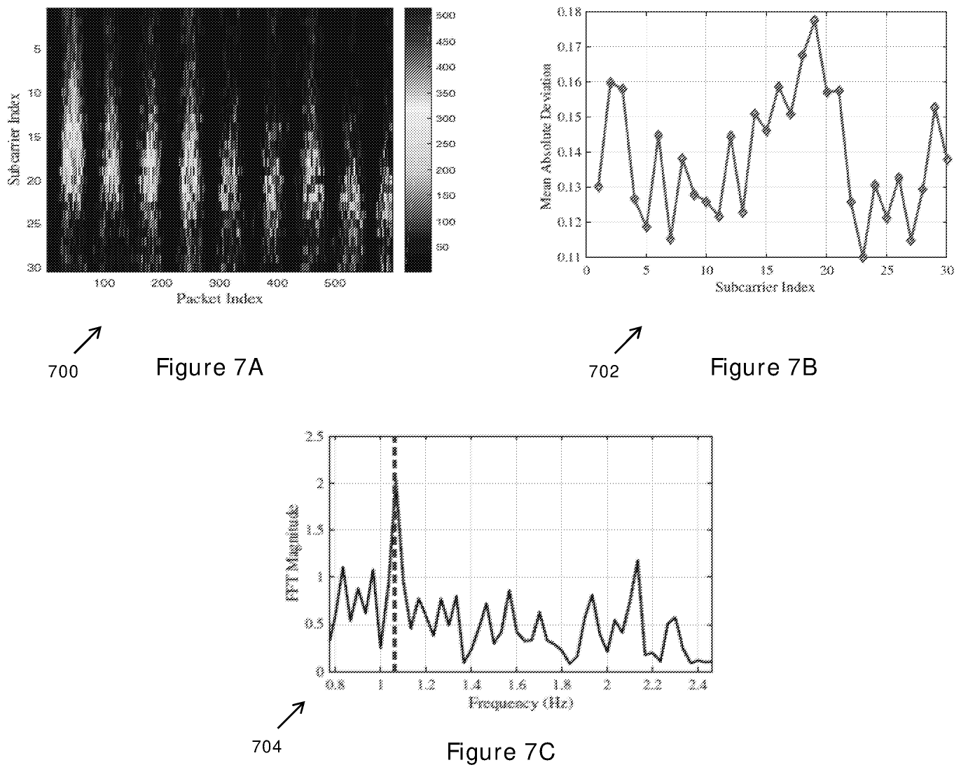

‘PhaseBeat: Exploiting CSI Phase Data for Vital Sign Monitoring with Commodity WiFi Devices’ (Xuyu Wang, Chao Yang, and Shiwen Mao. 2017) provides another example of breathing rate and heart rate estimation using CSI of WLAN signals. Illustration 700 of FIG. 7A shows the CSI phase difference series patterns after data calibration. We can see that the neighboring subcarriers of subcarrier 20 have higher sensitivity to breathing signals. Then, as shown in illustration 702 of FIG. 7B, the mean absolute deviation of CSI phase difference data of subcarrier 19 is the maximum. Fast fourier transform (FFT) based methods are applied to the selected subcarriers (e.g., subcarrier 19) to estimate the heart rate as shown in illustration 704 of FIG. 7C. After finding the peak of FFT, we use the three bins, including the peak bin and its two adjacent bins, where an inverse FFT is performed to obtain a complex time-domain signal.

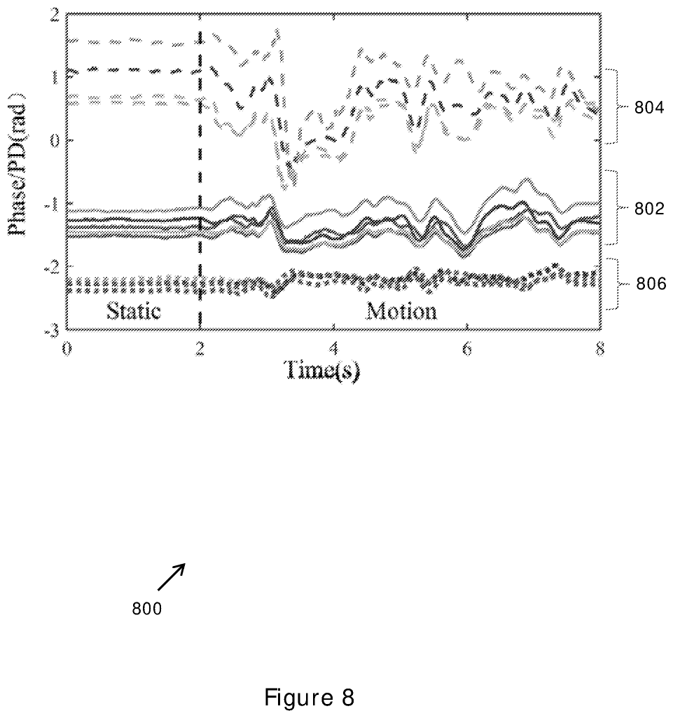

‘Light Weight Passive Human Motion Detection with WiFi’ (Xu Wang, Linghua Zhang. 2021) provides an example of Human Motion Sensing using WLAN CSI and shows that for a multi-input multi-output (MIMO) WiFi system, there are always variations between different subcarriers when a human moves due to signals being attenuated differently across the frequency band. Illustration 800 of FIG. 8 shows an example of this phenomenon. For the sake of clarity, only 13 representative subcarriers are considered. From FIG. 8, the authors find that the response of some subcarriers to human motion is similar, such as the 5 subcarriers which are plotted by solid line (see reference 802). The authors termed these subcarriers as a pattern in their works. The authors also find that different patterns responses diversely to the environment, as indicated by the dashed (see reference 804), solid (see reference 802), and dotted lines (see reference 806), respectively. A motion sensitive pattern shows poor stability in static environment, thus, the slight fluctuation caused by human motion would be easily submerged in noise when an oversensitive subcarrier is selected. Therefore, oversensitive subcarriers are discarded, and among the remaining subcarriers, the subcarrier cluster with the highest similarities are chosen for motion detection. ‘Light Weight Passive Human Motion Detection with WiFi’ (Xu Wang, Linghua Zhang. 2021) thus highlights that subcarriers of interests may be extended to group(s) of subcarrier of interest.

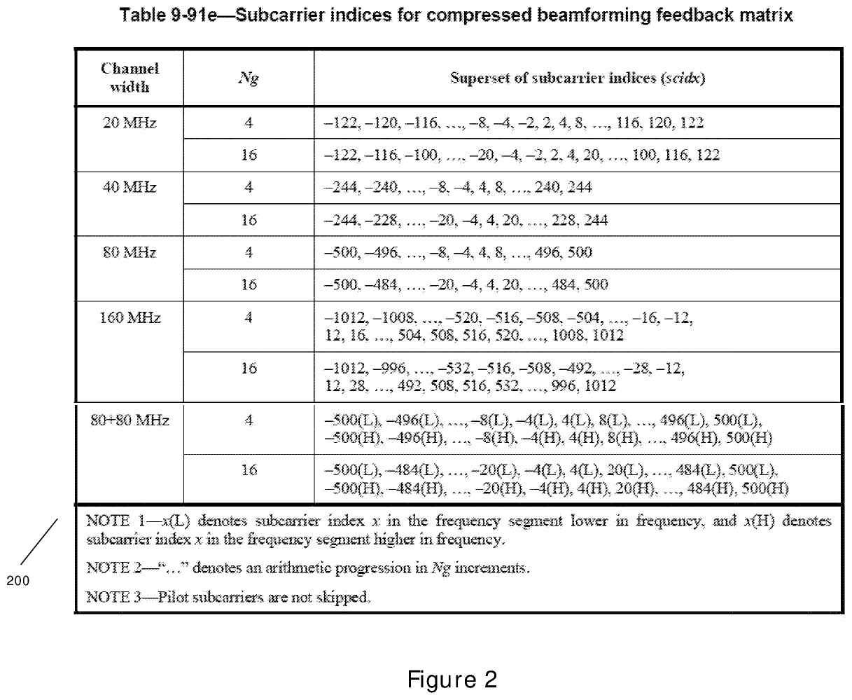

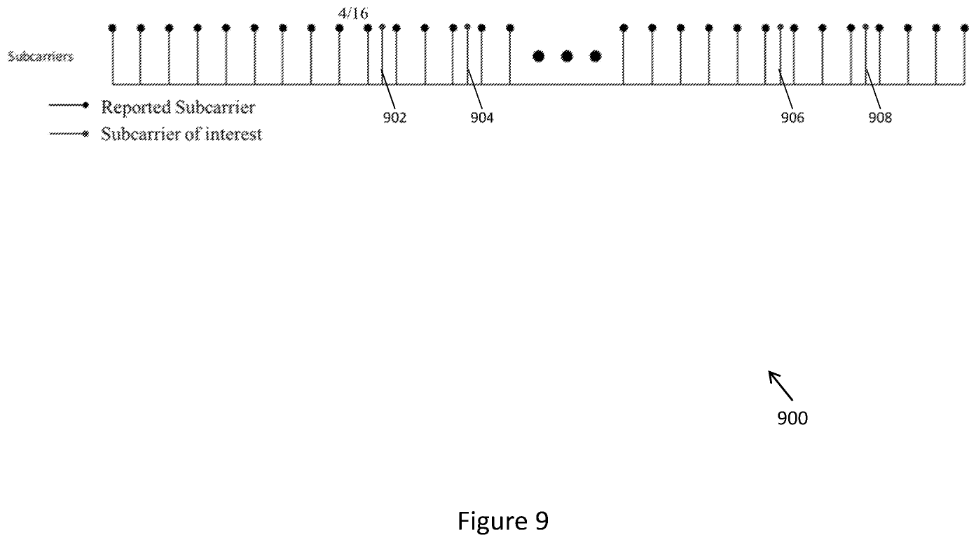

As noted in the above discussions and as illustration in FIG. 2, 11ax and 11be (baseline for sub-7 GHz 11 bf) only supports Ng=4 and 16, and the indices of the reported subcarrier are fixed by the standard. Assuming 11 bf adopts the same Ng values, if a high value is chosen, the CSI feedback may miss many subcarriers of interest, while if a low value is chosen, the CSI feedback overhead will be large. For example, referring to illustration 900 of FIG. 9, the lines without any labels represent the subcarriers that are selected for feedback based on the indicated Ng value, and it can be seen that subcarriers of interest 902, 904, 906 and 908 may be missed and not reported if a high Ng value is used, and if the indices of the subcarriers of interest are not among the indices listed in the 802.11 specification for the indicated Ng value. It is therefore desirable to propose a more flexible subcarrier selection/reporting scheme and related signaling while keeping the CSI feedback overhead low.

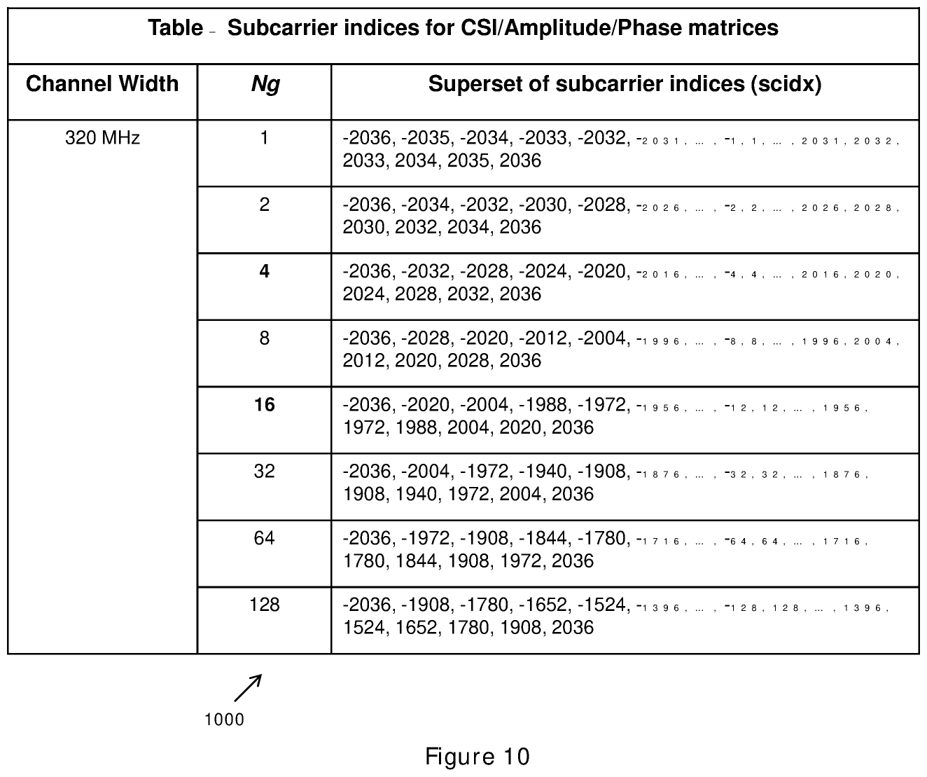

For CSI feedback reporting, a more dynamic range of Ng may be standardized, which is different from the values used for the compressed beamforming feedback matrix reporting. For example, using 3 bits for Ng, 8 different values of Ng can be signaled. An example set of reported subcarriers for 320 MHz channel is shown in Table 1000 of FIG. 10. It will be appreciated that subcarrier indices for other applicable channel widths besides 320 MHz may be similarly derived, and larger values of Ng may be applicable for wider channels only (e.g., 320 MHz). Accordingly, the finest Ng value may be chosen based on the table 1000 such that all subcarriers of interest are included in the CSI measurement report. However, this results in an increase in the feedback size, especially if the indices of the subcarriers of interest are not divisible by 2, which means Ng value of 1 needs to be selected.

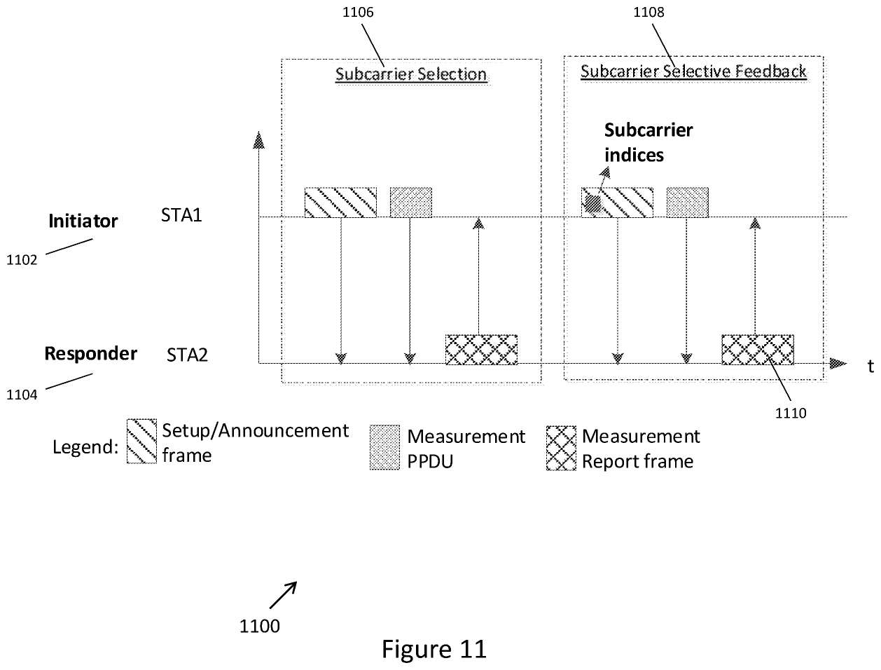

Referring to illustration 1100 of FIG. 11, during an initial sounding session 1106, an Initiator STA 1102 may perform one or more rounds of channel sounding to collect one or more sets of channel information feedback and use these to select subcarriers of interest as previously described. Subcarriers of interest is defined as a subset of subcarriers (out of the set of all subcarriers within the channel bandwidth) whose channel information feedback is considered to be of special interest for the Initiator STA and/or for the applications that make use of the channel information. Channel information feedback may be channel state information (CSI) feedback or compressed/noncompressed beamforming feedback. During a subsequent sounding session 1108, the Initiator STA 1102 may indicate the subcarrier indices for which channel information feedback is solicited. Thus, responder/receiver 1104 only includes the channel information feedback for the indicated subcarriers in the measurement report. This may be referred to as Subcarrier Selective feedback. Accordingly, channel information feedback may be included in a measurement report frame 1110 (transmitted from responder 1104 to initiator 1102) only for the indicated subcarrier indices.

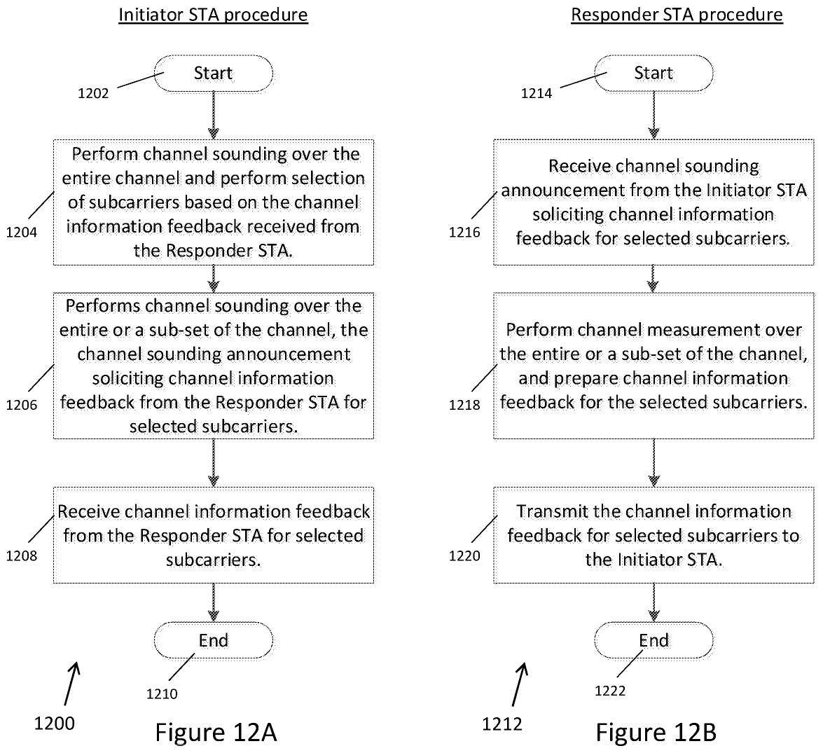

FIG. 12A depicts an example flowchart 1200 of an initiator STA procedure. The process starts at step 1202. At step 1204, channel sounding is performed over an entire channel and selection of subcarriers is performed based on channel information feedback received from the responder STA. At step 1206, channel sounding is performed over the entire channel or a subset of the channel, the channel sounding announcement soliciting channel information feedback from the responder STA for selected subcarriers. At step 1208, channel information feedback for the selected subcarriers is received by the initiator STA from the responder STA. The process ends at step 1210.

FIG. 12B depicts an example flowchart 1212 of a responder STA procedure. The process starts at step 1214. At step 1216, channel sounding announcement is received from an initiator STA soliciting channel information feedback for selected subcarriers. At step 1218, channel measurement is performed over the entire channel or a subset of the channel, and channel information feedback is prepared for the selected subcarriers. At step 1220, the prepared channel information feedback for the selected subcarriers is transmitted from the responder STA to the initiator STA. The process ends at step 1222.

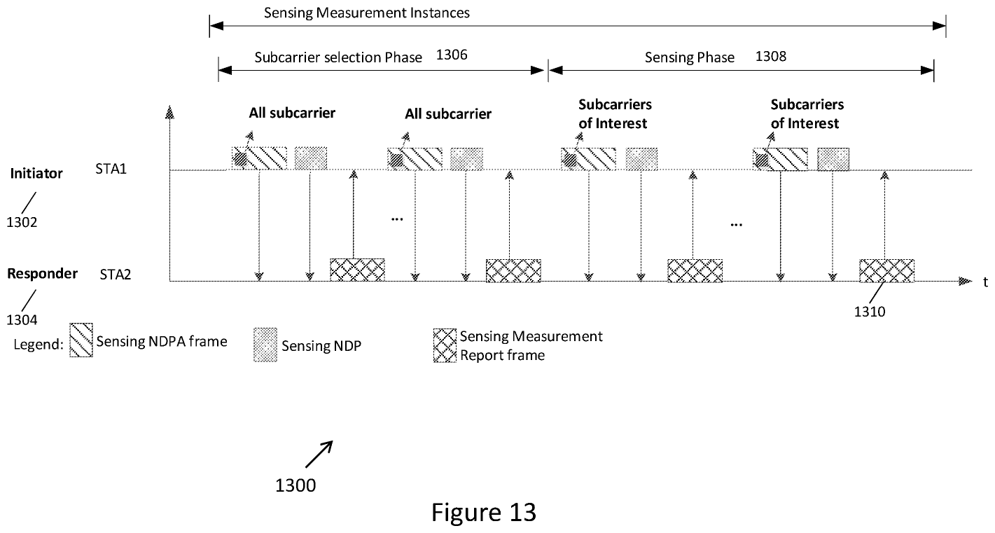

In an embodiment E1, referring to sensing measurement illustration 1300 of FIG. 13 during an initial phase (e.g., subcarrier selection phase 1306), an initiator 1302 may perform one or more round of sounding (e.g., using non-Trigger Based (TB) sounding sequence) and collect one or more rounds of full CSI feedback (e.g., for all subcarriers using Ng=1). It may then apply application specific schemes to select the subcarriers of interest as described earlier. Other methods may also be used to select subcarriers of interest, for example for breathing analysis, Respiration energy ratio (RER) is a popular parameter to select subcarriers of interest. Respiration energy ratio (RER) is defined as the ratio of the amount of energy that falls within the respiration frequency band to the total energy in the spectrum. Empirically, the RER can be computed with the Fast Fourier transform (FFT). Subcarriers with low RER or variance larger than certain percentile are discarded to improve the estimation accuracy. RER may also be expressed as breathing-to-noise ratio (BNR) which is defined as the ratio of respiration energy to the overall energy. Depending on the sensing application, the location (in frequency) of the subcarriers of interest and the distances between two nearest subcarriers of interest may be different for different segments of the channel being senses. While many subcarriers of interest may be located in some segments, relatively few or even none may be located in other segments. In order to collect CSI feedback from as many of the subcarriers of interest as possible, while keeping the overhead of the CSI feedback low, during a later phase (e.g., sensing phase 1308), initiator STA 1302 implicitly indicates the subcarrier indices for which CSI feedback is solicited by specifying different Ng values for different segments of the channel. Segments of the channel may be Resource Units (RU) or Multiple RUs (MRU), or may also be subchannels (e.g., 20 MHz/40 MHz). For example, a 160 MHz channel may be divided into 8 segments, each segment being a 242 tones RU, or may be divided into 4 segments, each segment being a 40 MHz subchannel etc. The Responder/Receiver STA 1304 then only includes the CSI feedback in the Sensing Measurement Report frame 1310 for the subcarriers that are selected based on the Ng values for different segments. Subcarriers of interest may also drift over time and the Initiator STA 1302 may need to perform full CSI feedback periodically and re-perform subcarrier selection. Although not shown in FIG. 13, the different phases may be negotiated as different Measurement Setups and each phase identified by a different Measurement Setup ID. Also, the Sensing NDPs in FIG. 13 may also be called I2R NDP, and although not shown the figure, may also be followed by the transmission of a R2I NDP by the Responder STA 1304 within SIFS of end of reception of the I2R NDP, and finally followed by the transmission of the Sensing Measurement Report frame carrying the CSI feedback measured based on the I2R NDP.

In this disclosure, we are proposing that a sensing initiator is allowed to solicit partial bandwidth CSI feedback from a single sensing responder STA even in a non-TB sounding sequence. However, it is to be noted that this is not allowed for HE/EHT STAs for compressed beamforming feedback as per IEEE 802.11 specification.

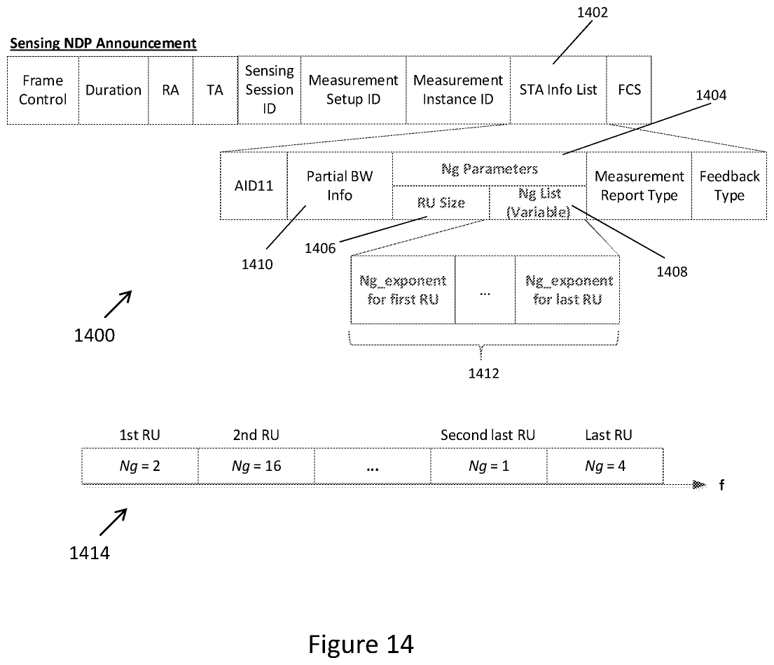

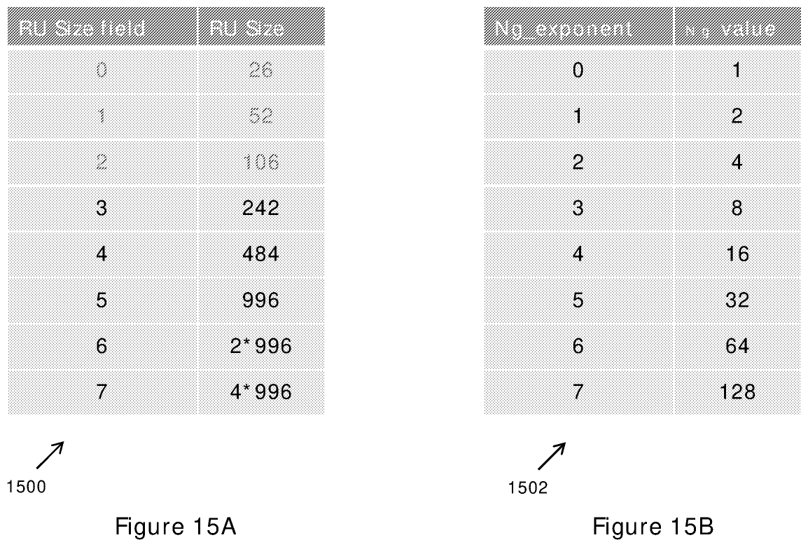

In an embodiment E1, an initiator may indicate different Ng values for different segments in a Sensing NDPA, for example sensing NDPA frame 1400 of FIG. 14. Ng values for the segments are indicated as a list of Ng_exponent values in the Ng List subfield 1408 within the Ng Parameters field 1404 in the STA Info List field 1402 of the Sensing NDPA frame 1400. RU Size subfield 1406 in the Ng parameter field 1404 indicates the size of the segments into which the RU/MRU signaled in the Partial BW Info field 1410 is equally sub-divided into for the purpose of Ng differentiated CSI feedback. Example encoding of the RU Size field 1406 are shown in Table 1500 of FIG. 15A. Using different Ng values for different segments of the channel during the sound feedback is known as Ng differentiated CSI feedback. For practical purposes, the smallest segment may be limited to 242-tone RU (=20 MHz).

The size of the Ng List subfield 1408 depends on the number of segments into which the RU/MRU indicated in the partial BW Info subfield 1410 is sub-divided into, the Ng value of each segment indicated by a corresponding Ng_exponent subfield within the Ng List subfield 1408, e.g., each Ng_exponent subfield using 3 bits. A Ng_exponent subfield is included in the Ng List subfield only for a channel segment that is indicated as being solicited for feedback in the Partial BW Info field 1410. In order words, a Ng_exponent subfield is not included in the Ng List subfield for a channel segments that is not solicited for feedback as per the Partial BW Info field. Here, the Partial BW Info field is assumed to have the same format and encoding as the Partial BW Info field in an EHT NDPA frame 300 in FIG. 3. In a Sensing NDPA, the Partial BW Info field may also be called Feedback BW Info field to better reflect the usage in Sensing. In the event that Ng differentiated CSI feedback is not applied (e.g., in the initial subcarrier selection phase), a single Ng value may apply for the entire feedback RU/subchannel, wherein the RU Size subfield 1406 indicates a RU/MRU size that is equal or larger than the entire feedback RU/MRU size and the Ng List subfield 1408 contains a single Ng_exponent subfield 1412 that indicates the single Ng value. For example, if the feedback MU/MRU indicated in the partial BW Info field 1410 is a 484+242 MRU and a single Ng value applies, the Ng Parameters field 1404 contains a single Ng_exponent subfield 1412 (e.g. =4), and the RU Size subfield 1406 indicates (5 i.e. 996-tone RU). Alternatively, it is also possible that for the case when Ng differentiated CSI feedback is not applied, the Ng Parameter subfield 1404 is replaced with a single subfield indicating the Ng value. In this case, a separate field (e.g., using 1 bit) may indicate whether Ng differentiated CSI feedback is not applied or not. The Ng List subfield 1408 indicates the Ng values for each segment for which feedback is solicited. An example of indicated Ng values is shown in example Ng list subfield 1414, and example encoding of Ng_exponent fields 1412 are shown in Table 1502 of FIG. 15B.

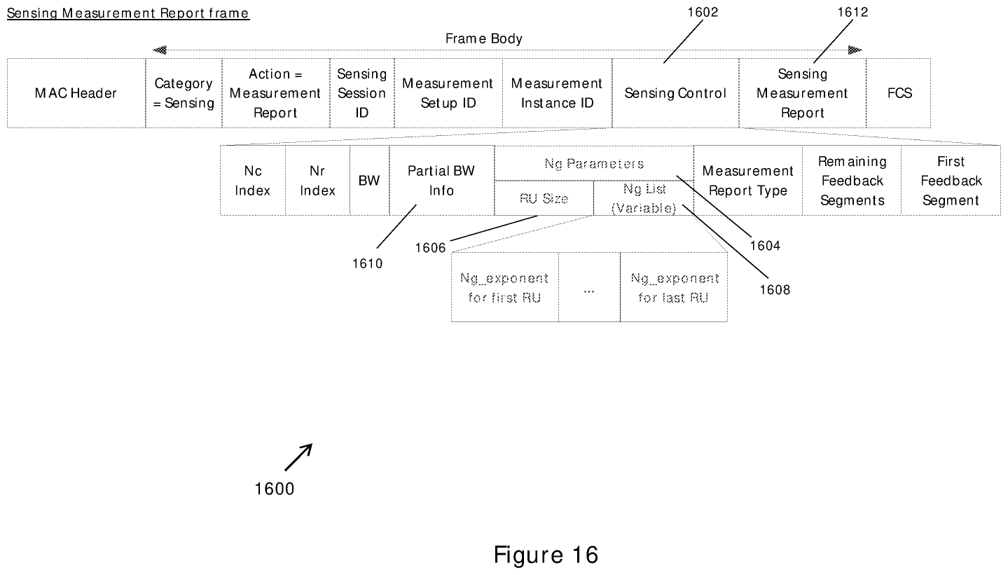

In an embodiment E1, for each channel segment, a Responder STA may include the CSI feedback for the indicated subcarriers (as per the Ng value per segment) in a measurement report, such as Sensing Measurement Report frame 1600 of FIG. 16. The encoding and meaning of Ng parameters subfield 1604 in the sensing measurement report frame 1600 is the same as that of a sensing NDPA (e.g., sensing NDPA frame 1400). The Ng values for the segments are indicated as a list of Ng_exponent values in Ng List subfield 1608 within the Ng Parameters field 1604 in the Sensing Control field 1602 of the Sensing Measurement Report frame 1600. The RU Size subfield 1606 of the Ng parameter field 1604 indicates the size of the segments into which the RU/MRU signaled in the Partial BW Info field 1610 is equally sub-divided into for the purpose of Ng differentiated CSI feedback. The size of the Ng List subfield 1608 depends on the number of segments into which the RU/MRU indicated in the partial BW Info subfield 1610 is sub-divided into, the Ng value of each segment indicated by a corresponding Ng_exponent subfield within the Ng List subfield 1604, e.g., each Ng_exponent field using 3 bits.

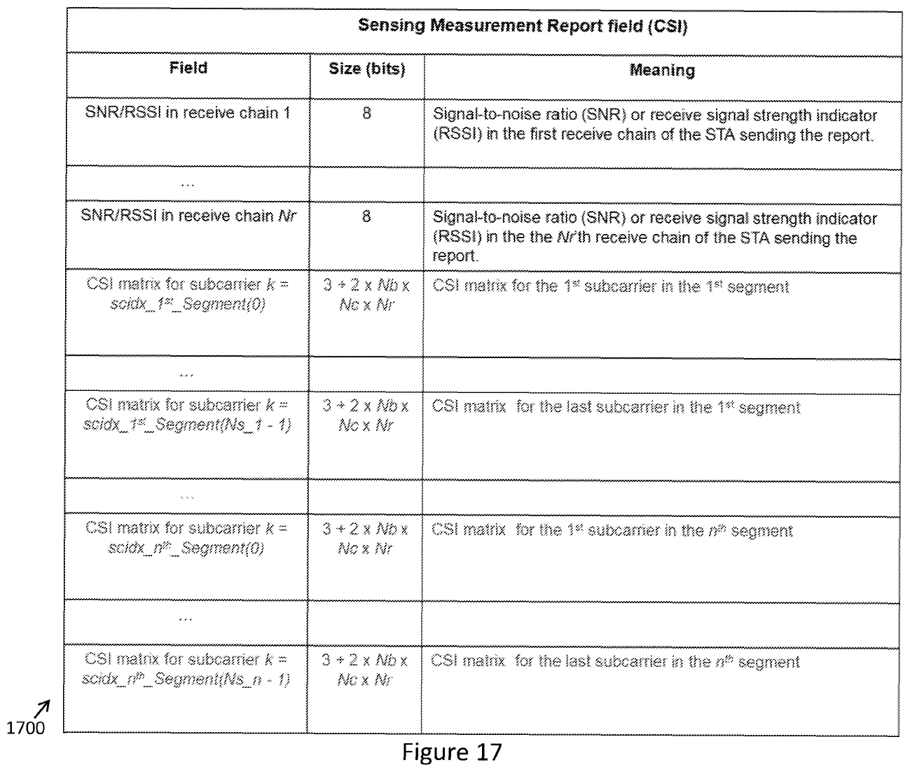

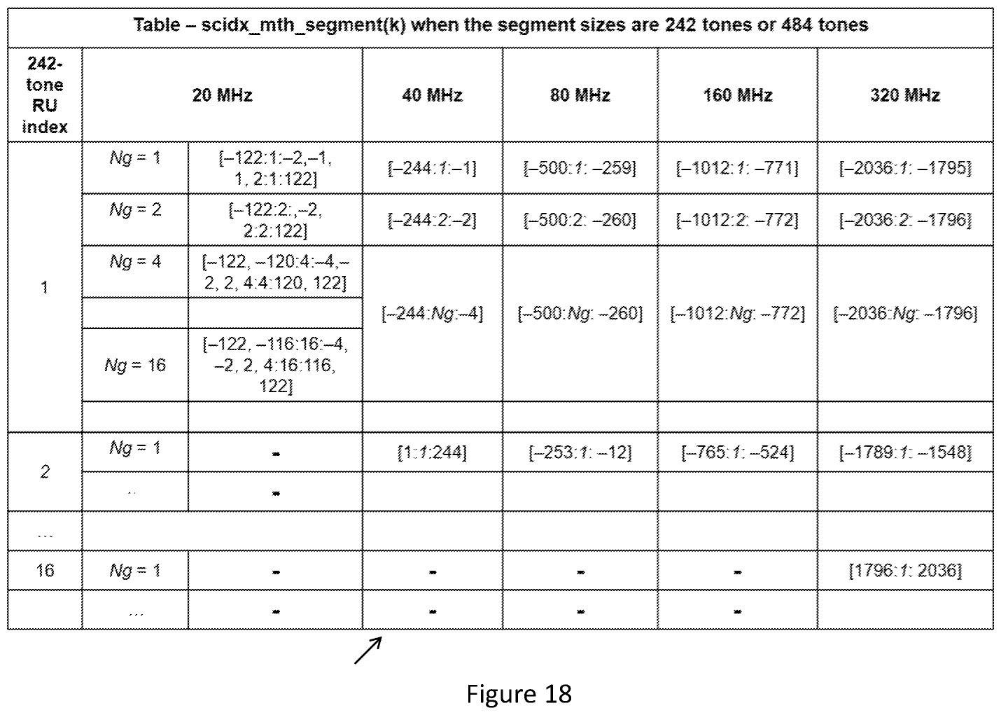

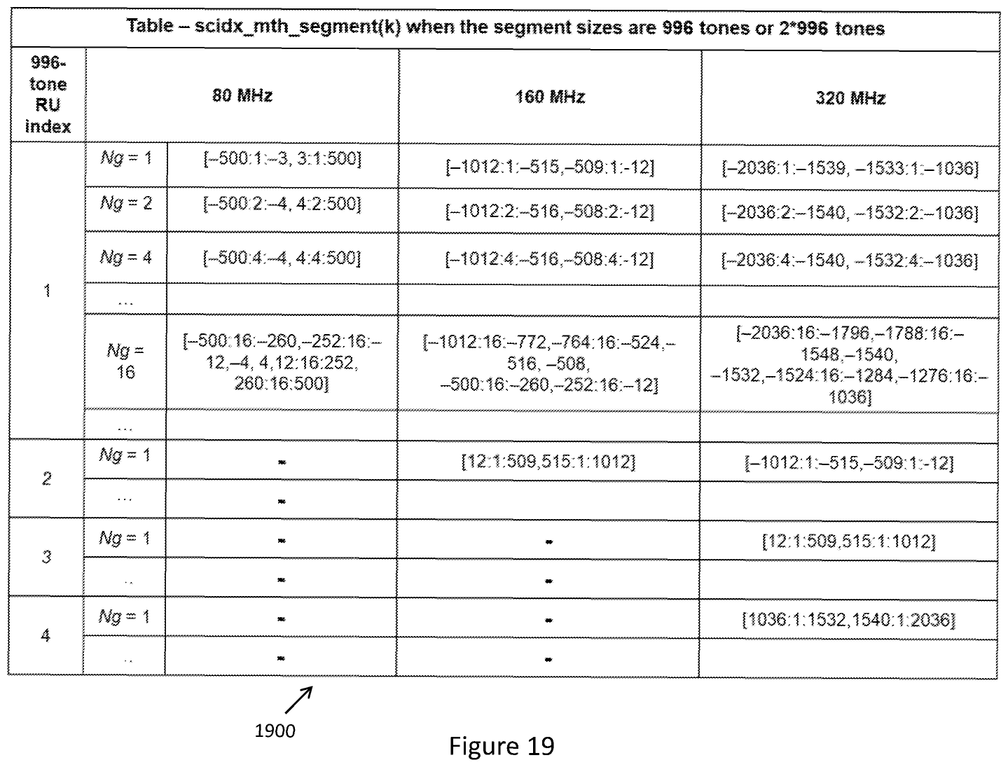

Further, sizes of a Sensing Measurement Report field (for example, Sensing Measurement Report field 1612 of Sensing Measurement Report frame 1600) are shown in table 1700 of FIG. 17. The index of a subcarrier k in the mth segment (e.g., scidx_mth_segment(k)) for various values of Ng parameters and for various operating channel bandwidth are defined in table 1800 of FIG. 18 for when segment sizes are 242 tones or 484 tones, and defined in table 1900 of FIG. 19 for when segment sizes are 996 tones or 2*996 tones. The values of scidx_mth_segment(k) defined in tables 1800 and 1900 indicate the exact subcarrier index corresponding to the reported subcarrier k for the mth segment. Ns_m is the number of subcarriers for which the CSI matrix is reported in the mth segment and is a function of the grouping parameter Ng for that segment. Only a single CSI matrix is reported for each group of Ng adjacent subcarriers. The total number of reported subcarriers is defined as Ns=Σ=ₘ₌₁^{m=n}Ns_m, n being the total number of segments into which the channel to be sensed is divided into. As for the Sensing Measurement Report field 1612, it is also possible that the field may be carried within an Extended Information element, e.g., a Sensing Measurement Report element. It is to be noted that since the size of Extended elements are limited (254 octets), more than one element may be required to carry the Sensing Measurement Report.

Referring to table 1800, the subcarrier indices for various channel bandwidth for various values of Ng when the segment sizes are 242 tones or 484 tones are listed. [x,y,z] represents a sequence of indices where x, y and z denotes the RU Start index (e.g. the lowest index number in the RU), step, and RU End index (e.g. the highest index number in the RU), respectively. The grouping parameter Ng as shown in the table denotes an arithmetic progression in Ng increments. When the segment size is 242 tones, the 242-tone RU index corresponds to the segment index, i.e., the first segment is same as the 242-tone RU with the 242-tone RU index 1 and so on. When the segment size is 484 tones, the first segment is composed of the two 242-tone RUs with the 242-tone RU indices 1 and 2 and so on. The select combinations of 242-tone RU indices and Ng are shown in Table 1800 and the other combinations are omitted. For a 242-tone RU, the subcarrier indices are computed using the following: when Ng=1, all data and pilot subcarriers listed in the applicable 802.11 specification (e.g., in the 802.11ax(HE) or 802.11be(EHT)), e.g., in a 160 MHz EHT PPDU, the first 242-tone RU=[−1012: −771] and the 2^{nd} 242-tone RU=[−765: −524] etc. When Ng=x (>1), subcarrier indices are selected from among the subcarriers for Ng=1 such that the lowest index is always included (e.g., −1012) and starting from the lowest index, subcarriers are selected at a distance of the Ng value (e.g., x). Null subcarriers listed in the specification (e.g., ±254, ±255, ±256, ±257, ±258) are excluded. When the segment size is 484 tones, the subcarrier indices will be based on two consecutive 242-tone RUs listed in table 1800, e.g., the Primary 40 MHz segment will be based on the 242-tone RU indices 1 & 2 etc. The table 1800 is based on EHT tone plan and assuming EHT Sounding NDP is used for Sensing measurements. If HE tone plans and HE Sounding PPDU are used, and the Partial BW Info subfield in the sensing NDPA frame and the sensing measurement report frame indicates Start RU Index and End RU Index, the subcarrier indices for Ng values other than 4 and 16 are tabulated similarly to Table 9-91c—(Subcarrier indices scidx(0) and scidx(Ns−1) for Ng=4) and Table 9-91d—(Subcarrier indices scidx(0) and scidx(Ns−1) for Ng=16) of the IEEE 802.11ax-2021 specification. When all bits in the Partial BW Info subfield corresponding to the 80 MHz subblock are set to 1 and the RU Size subfield in the Ng parameters subfield indicate 242-tones RU, each 80 MHz subblock may be divided into four 242-tones segments and the tone plan based on 242-tones RU (e.g. as shown in table 1800) is used to select the subcarriers for the different values of Ng in each 242-tone segment.

Referring to table 1900, the subcarrier indices for various channel bandwidth for various values of Ng when the segment sizes are 996 tones or 2*996 tones are listed. The grouping parameter Ng as shown in the table denotes an arithmetic progression in Ng increments. Only the reported subcarrier indices for selected Ng values are listed here, but the subcarrier indices for other values of Ng can be similarly derived. The table 1900 is based on EHT tone plan and assumes that EHT Sounding NDP is used for sensing measurements and the RU Size subfield in the Ng parameters subfield indicate 996-tones RU or larger. When the segment size is 2*996 tones, the subcarrier indices will be based on two consecutive 996-tone RUs listed in table 4B, e.g., the Primary 160 MHz segment will be based on the 996-tone RU indices 1 & 2 and the secondary 160 MHz segment will be based on the 996-tone RU indices 3 & 4. Segment sizes 996 tones or larger can be used only when all bits in the Partial BW Info subfield corresponding to the 80 MHz subblock(s) are set to 1. when not all bits in the Partial BW Info subfield corresponding to the 80 MHz subblock(s) are set to 1, segments sizes of 242 tones or 484 tones should be used and the subcarrier indices will be based on the relevant 242-tone RUs listed in table 1800.

The CSI matrix (for subcarrier k) may have the following structure:

For each reported subcarrier k include

```
{
  Carrier Matrix Amplitude of 3 bits (MH(k))
  For each of Nr rows in each CSI matrix in order: (1, ..., Nr)
  {
    Include Nc complex coefficients of the CSI matrix H_{eff}; each element
    of H_{eff} includes the real part of the element (Nb bits) and imaginary
    part of the element (Nb bits) in that order.
  }
}
```

wherein the total size of the CSI feedback (except the SNR/RSSI fields) in bits=Ns×(3+2×Nb×Nc×Nr). Here, the total number of reported subcarriers Ns=Σ=ₘ₌₁^{m=n}Ns_m and Ns_m is the number of subcarriers for which the CSI matrix is reported in the m^{th} segment and is a function of the grouping parameter Ng for that segment and n is the total number of segments into which the channel to be sensed is divided into. Only a single CSI Matrix is reported for each group of Ng adjacent subcarriers. An advantageous effect is that the number of reported subcarriers can be adjusted for each reported RU/subchannels in a flexible manner while keeping the signaling overhead low.

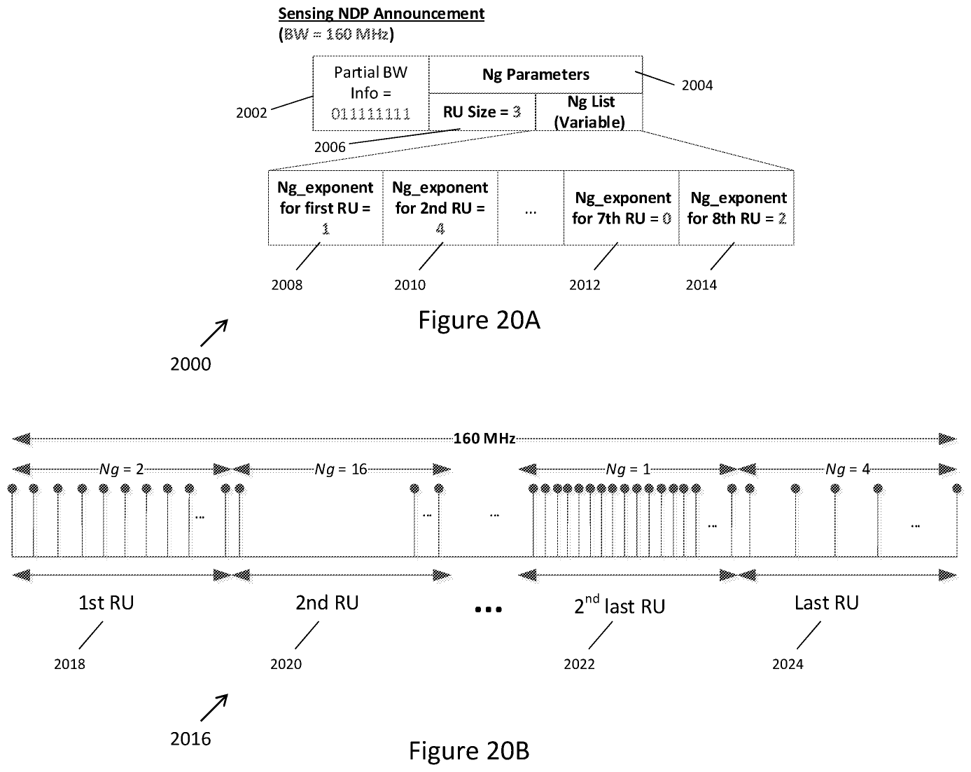

FIGS. 20A and 20B depict, respectively, an example illustration of a sensing NDPA frame 2000 and an example illustration 2016 of corresponding reported subcarriers based on a sensing bandwidth of 160 MHz according to an embodiment E1. The feedback RU/MRU size is indicated by partial BW Info field 2002 as “011111111”, or a 2*996 tones RU. For Ng parameter, RU size is indicated by RU size subfield 2006 of Ng parameters field 2004 as 3 (i.e., 242-tones) e.g., the 2*996-tones RU is sub-divided into 8 segments, each segment being a 242-tones (subcarriers) RU. In this case, the subcarrier indices are given in the first 8 RU indices of Table 1800, e.g., 242-tone RU indices 1 to 8, corresponding to the 160 MHz column. Accordingly, eight different Ng values (2, 16, 16, 16, 16, 16, 1, 4) are indicated for each of the eight 242-tones RUs. In this example, the 2nd last RU 2022 (Ng exponent value indicated as ‘0’ in Ng list subfield 2012, so that Ng value=2\hat{ }0=1), the 1st RU 2018 (Ng exponent value indicated as ‘1’ in Ng list subfield 2008, so that Ng value=2\hat{ }1=2), the last RU 2024 (Ng exponent value indicated as ‘2’ in Ng list subfield 2014, so that Ng value=2 \hat{ }2=4) are of special interest (in decreasing order) for the sensing application and hence smaller values of Ng are indicated for these RUs, while the 2nd to 6th RUs are not of special interests (and hence large values of Ng are indicated for these RUs, for example Ng value is indicated as ‘4’ in Ng list subfield 2010 for 2nd RU 2020, so that Ng value=2\hat{ }4=16). Assuming that 3 bits are used to signal the RU Size and Ng_exponent in the sensing NDPA frame 2000, and number of segments to be reported is 8 (or 160 MHz/20), overhead for the Ng signaling may be the number of extra bits required to signal Ng values which is calculated as 3+(3*8)=27 bits. Further, the total number of reported subcarriers (Ns)=122+18×5+244+64=520, and savings in the form of omitted subcarriers (compared to the case where all subcarriers are reported, i.e., assuming Ng=1 for 2*996-tone RU)=1988−520=1468. Assuming that Nb=8, Nc=3, Nr=3, this advantageously translates into an overhead reduction of (1468×(3+2×8×3×3)−27) bits=26,971 octets.

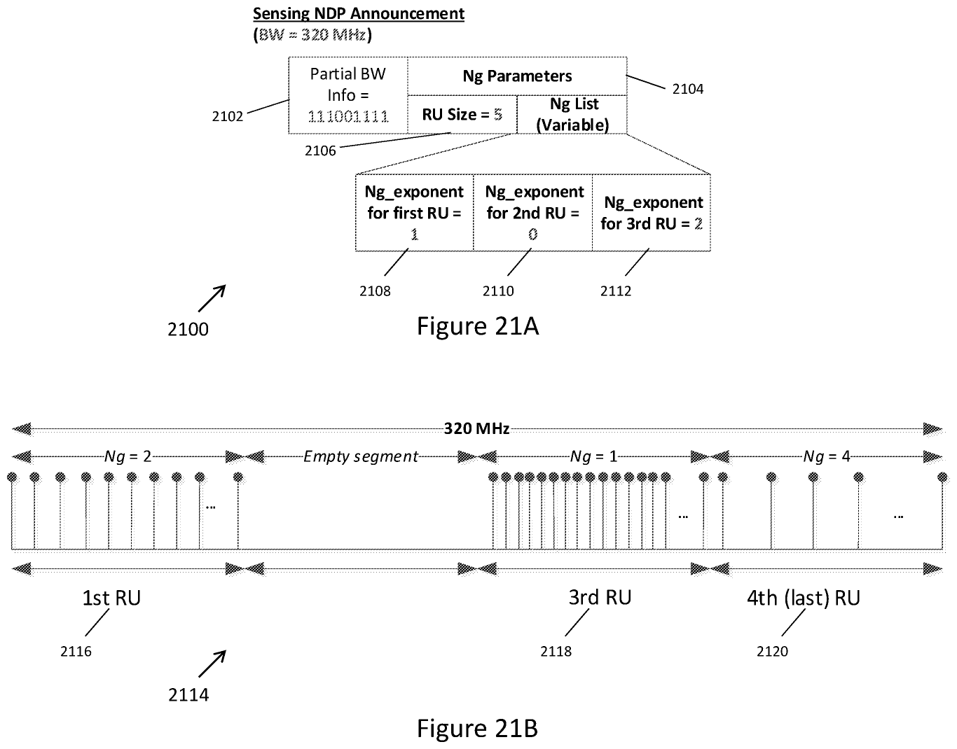

FIGS. 21A and 21B depict, respectively, an example illustration of a sensing NDPA frame 2100 and an example illustration 2114 of corresponding reported subcarriers based on a sensing bandwidth of 320 MHz according to an embodiment E1. The feedback RU/MRU size is indicated by partial BW Info field 2102 as “111001111”, or a 3*996 tone MRU with the 2^{nd} 996-tone RU being punctured. For Ng parameters, RU size is indicated by RU size subfield 2106 of Ng parameters field 2104 as 5 (i.e., 996-tones) e.g., the 3*996-tones feedback MRU is sub-divided into 3 segments, each segment being a 996-tones (subcarriers) RU. In this case, the subcarrier indices are given in the first, third and fourth 996-tone RU indices of Table 1900, corresponding to the 320 MHz column. Accordingly, three different Ng values (2, 1, 4) are indicated for each of the three 996-tones RUs. For example, Ng exponent value for the 2nd last RU 2118 is indicated as ‘0’ in Ng list subfield 2110 so that Ng value=2\hat{ }0=1, Ng exponent value for the 1st RU 2116 is indicated as ‘1’ in Ng list subfield 2108 so that Ng value=2\hat{ }1=2, and Ng exponent value for the last RU 2120 is indicated as ‘2’ in Ng list subfield 2112, so that Ng value=2\hat{ }2=4. Assuming that 3 bits are used to signal the RU Size and Ng_exponent in the sensing NDPA frame 2000, and number of segments to be reported is 3 (or 3*996/996), overhead for the Ng signaling may be the number of extra bits required to signal Ng values which is calculated as 3+(3*3)=12 bits. Further, the total number of reported subcarriers (Ns)=122+244+64=430, and savings in the form of omitted carriers (assuming Ng=1 for 3*996-tone MRU)=2982−430=2552. Assuming that Nb=8, Nc=3, Nr=3, this advantageously translates into an overhead reduction of (2552×(3+2×8×3×3)−12) bits=46, 891.5 octets.

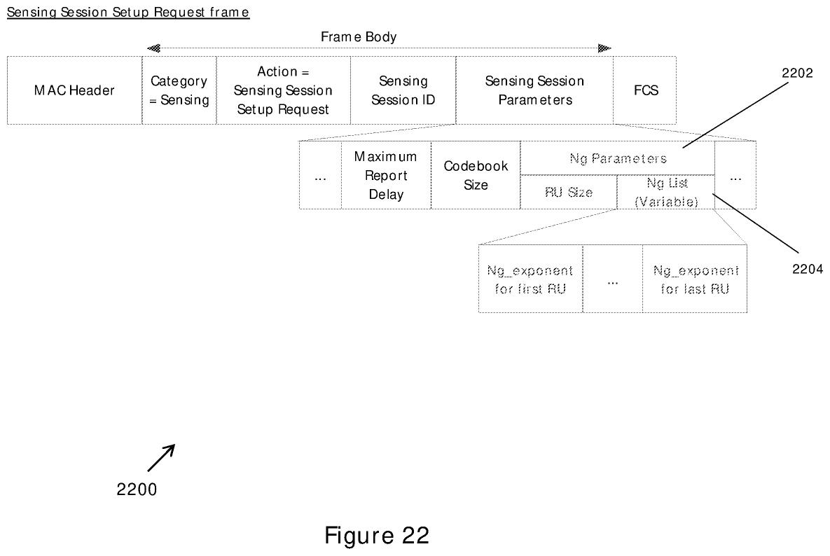

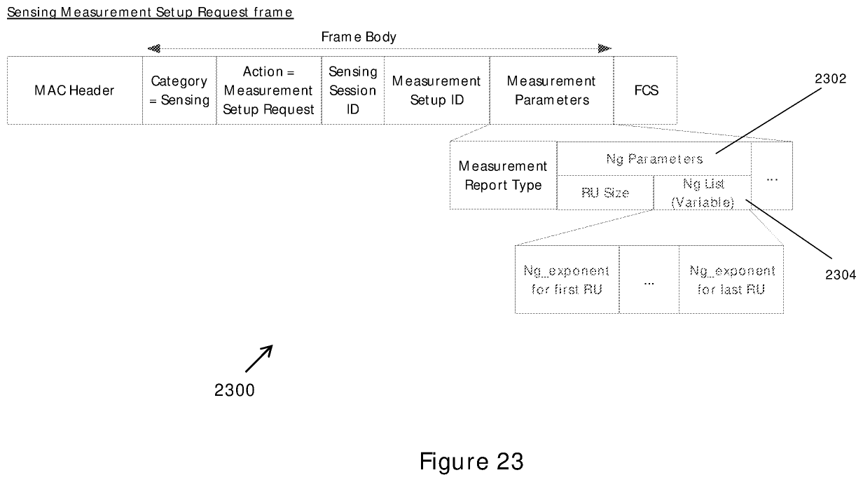

As alternative to sensing NDPA frame, an initiator STA may also indicate the Ng parameters during the sensing session setup itself (in a Sensing Session Setup Request frame) if the Ng parameters are expected to be fixed throughout a sensing session. For example, Sensing Session Setup Request frame 2200 of FIG. 22 may indicate the Ng parameters in Ng list subfield 2204 of Ng parameters field 2202, in a similar manner as shown for Sensing Measurement Report frame 1600. Alternatively, the Initiator STA may also indicate the Ng parameters during Sensing Measurement Setup (in a Sensing Measurement Setup Request frame) if the Ng parameters are expected to be fixed throughout a sensing measurement instances. For example, Sensing Measurement Setup Request frame 2300 of FIG. 23 may indicate the Ng parameters in Ng list subfield 2304 of Ng parameters field 2302, in a similar manner as shown for sensing measurement report frame 1600.

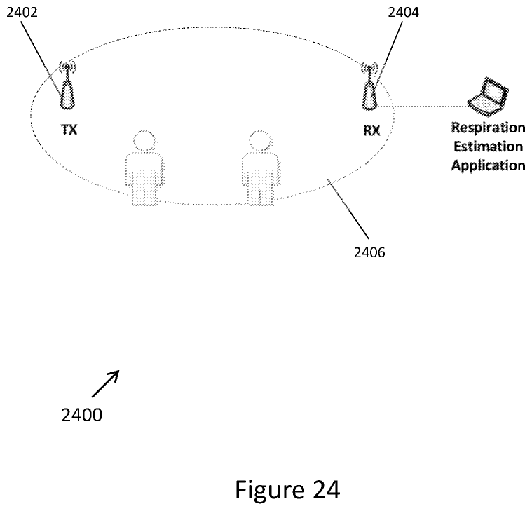

An example Respiration Estimation WLAN Sensing Application that uses Model based algorithm (e.g., based on Fresnel zone model) to detect and estimate human respiration rates is depicted in illustration 2400 of FIG. 24. A Fresnel zone 2406 is one of a series of ellipsoidal regions of space between and around a wireless transmitter 2402 and a wireless receiver 2404. A Fresnel reflection model in indoor environments can be used to estimate human respiration rate using WLAN sensing systems.

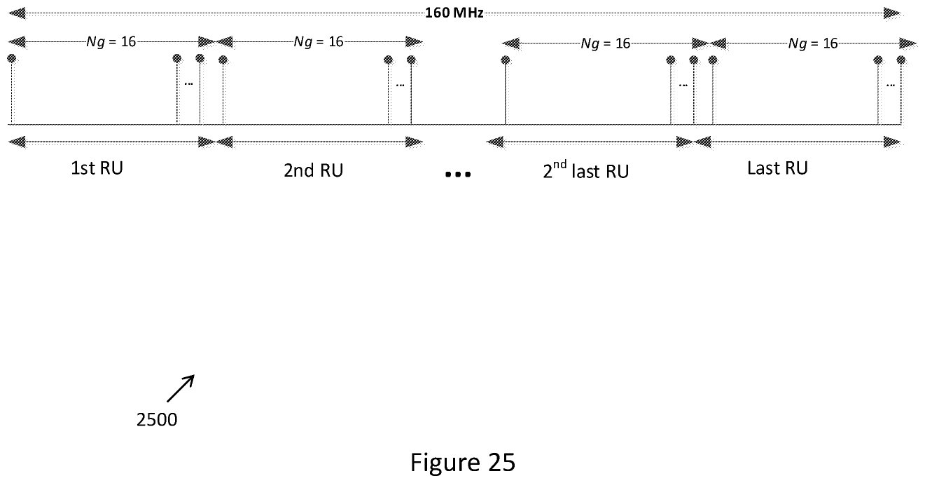

The curve of CSI amplitude across subcarriers can be highly sensitive to environmental changes and thus suitable for use in human presence detection. The Signal Tendency Index (STI) of the CSI amplitude data can provide a quantitative comparison of the shape similarity of CSI amplitude curves between an empty room and a room with one or more human beings present. A low STI score indicates that the room is empty while a high STI score indicates that one or more human beings are present in the room. Since this module needs to be constantly running, only coarse grain CSI feedback (e.g., with Ng=16 as shown in coarse grain CSI feedback sensing procedure illustration 2500 of FIG. 25) across the entire channel (e.g., 160 MHz as shown in illustration 2500) may be used.

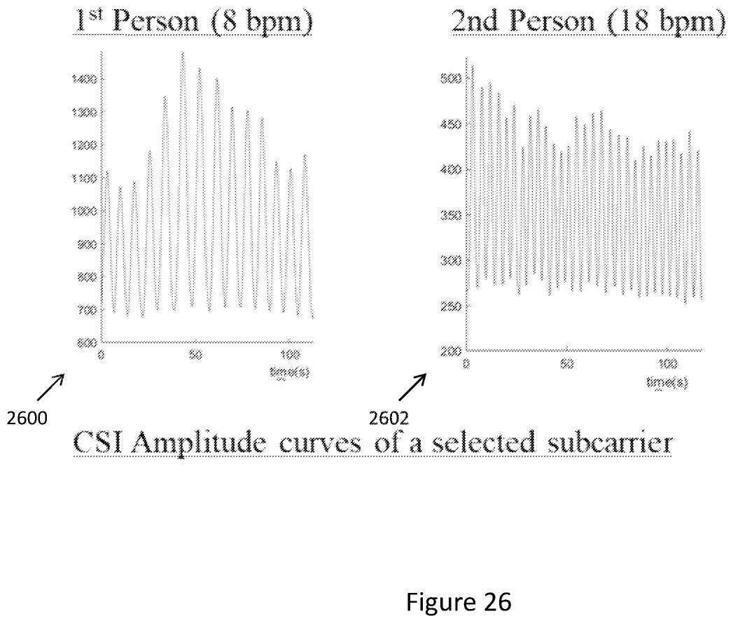

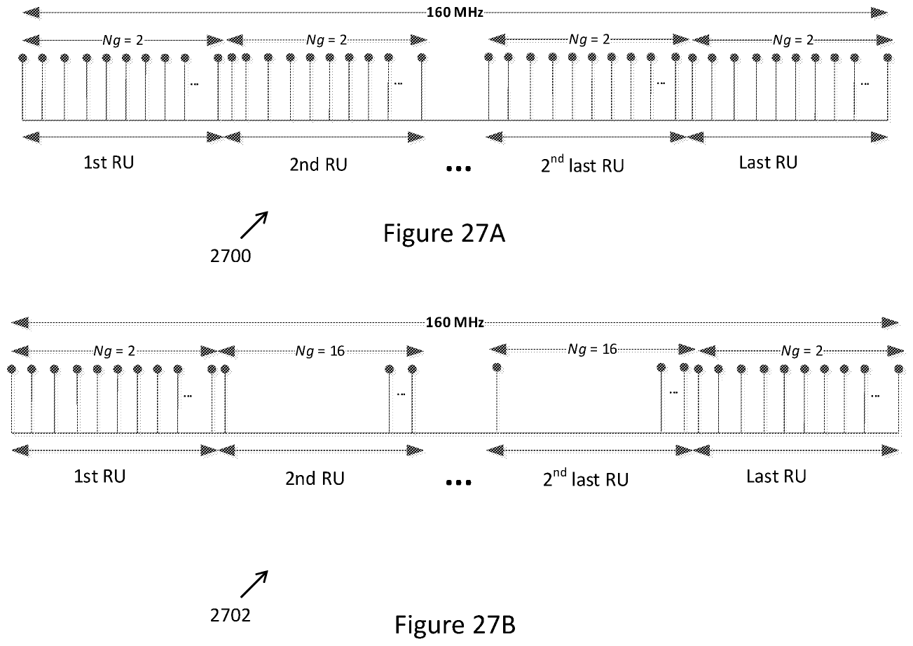

Once a human presence is detected, a mid-grained CSI feedback (e.g., using Ng=4, or Ng=2 as shown in CSI feedback sensing procedure illustration 2700 of FIG. 27A) across the entire channel is collected and techniques like power spectral density (PSD) is used to analyze the time series of CSI amplitude in frequency domain and determine how many human beings are present in the room, and also select the subcarriers that are most sensitive to each person's respiration rate. Since different people have different natural respiration rate, the indices of the subcarriers that are most sensitive to each person's respiration rate can be very different. For example, referring to CSI amplitude curves 2600 and 2602 of FIG. 26, the subcarriers in the first 242-tone RU (i.e., the first 20-MHz subchannel) may be most sensitive to a person with a low respiration rate (such as shown in CSI amplitude curve 2600 for a person with a low respiration rate of 8 bpm), while the subcarriers in the last 242-tone RU (i.e., the 8th 20 MHz subchannel) may be the most sensitive to a person with a high respiration rate (such as shown in CSI amplitude curve 2602 for a person with a high respiration rate of 18 bpm).

Finally, fine grained CSI feedback is performed at least for the channel segments where the subcarriers of interest are located (e.g., using Ng=1, or Ng=2 as shown in fine grain CSI feedback sensing procedure illustration 2702 of FIG. 27B), while only coarse grained CSI feedback is solicited for the rest of the channel segments, or those channel segments may be totally omitted in the CSI feedback (e.g., using Ng=16 as shown in fine grain CSI feedback sensing procedure illustration 2702). Techniques like peak detection is used on the CSI amplitude curves to estimate the respiration rates. Each peak and trough in the CSI amplitude curve of the selected subcarrier corresponds to the start of inhalation and exhalation respectively. By measuring the distances between two peaks (or two troughs) the respiration rates can be calculated.

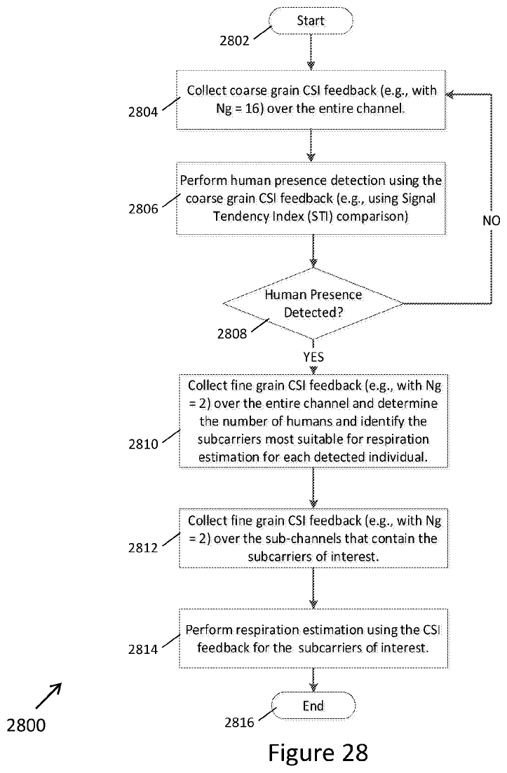

FIG. 28 shows an example flowchart 2800 for respiration estimation sensing process according to embodiment E1. The process starts from step 2802. At step 2804, coarse grain CSI feedback (e.g., with Ng=16) over the entire channel. At step 2806, human presence detection is performed using coarse grain CSI feedback (e.g., using STI comparison). At step 2808, it is determined whether human presence is detected based on the coarse grain CSI feedback. If it is determined that human presence is absent, the process loops back to step 2804. Otherwise, the process proceeds to step 2810 where fine grain CSI feedback (e.g., with Ng=2) is collected over the entire channel and the number of human beings are determined, and subcarriers that are most suitable for respiration estimation are identified for each detected human being. At step 2812, fine grain CSI feedback (e.g., with Ng=2) over the subchannels that contain the subcarriers of interest is collected. Step 2812 may be repeated a number of times to obtain fine grain CSI feedback over a period of time at a sufficiently high sampling rate, e.g., 20 times a second for a period of few minutes. At step 2814, respiration estimation (in terms of breathes per minute or bpm) is performed using the CSI feedback for the subcarriers of interest. The process then ends at step 2816.

While the above is an example of how subcarrier selective feedback can be used to obtain fine grained CSI feedback for sensing application while keeping the feedback overhead low, it will be appreciated that subcarrier selective feedback can be applied in similar manner to other sensing application as well as for beamforming feedback for communication applications as well.

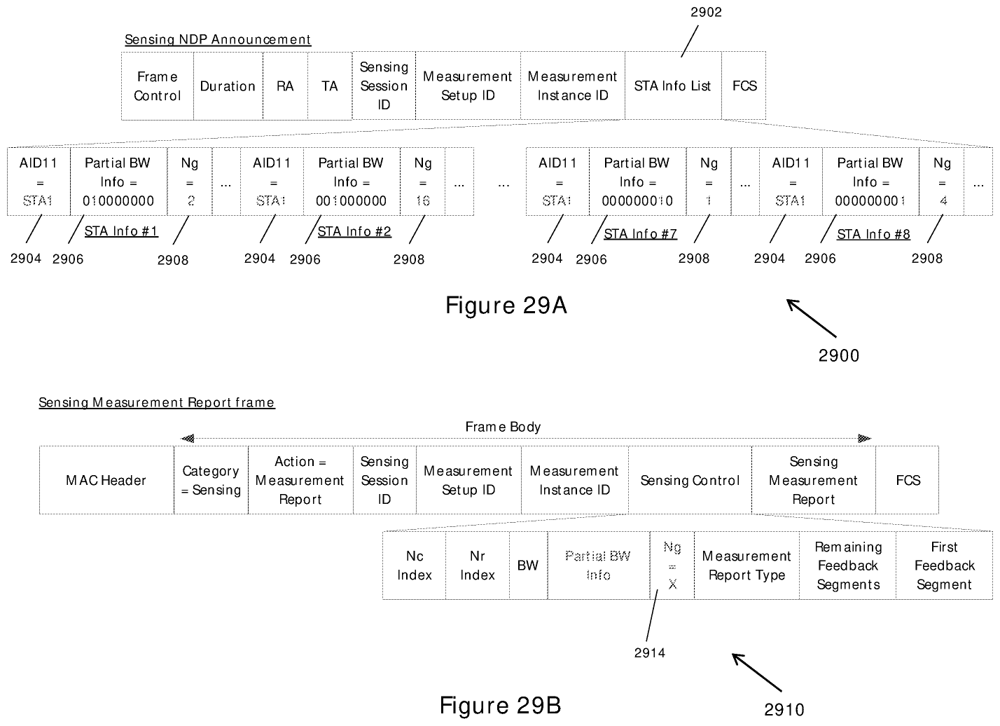

In an embodiment E2, an Initiator STA may indicate different Ng values for different segments by including multiple STA Info fields with the AID11 field set to the AID of the same STA 1, each STA Info field specifying a different segment of the channel and a same or different Ng value for that segment. HE/EHT currently indicates that an HE/EHT NDP Announcement frame shall not include multiple STA Info fields that have the same value in the AID11 subfield. However, this rule may be relaxed in future 802.11 amendments, e.g., 11 bf. For example, Sensing NDPA frame 2900 of FIG. 29A may be utilized for the example described for FIGS. 20A and 20B, in which STA Info list field 2902 includes multiple STA Info fields with each AID11 field 2904 set to the AID of the same STA 1, each STA Info field specifying a different segment of the channel in each partial BW info field 2906 and a same or different Ng value in each Ng field 2908 for a corresponding segment.

Further, a Responder/Receiver may generate multiple Sensing measurement reports, each report carrying the CSI feedback for one segment, the partial BW Info field indicating the channel segment and the Ng field 2914 indicating the Ng value used for that segment. The multiple measurement reports fields may be aggregated in a Sensing Measurement Report frame (for example Sensing Measurement Report frame 2910 of FIG. 29B), or multiple Sensing Measurement Report frames (each carrying one Sensing Measurement Report field) may be aggregated in a single A-MDPU. Advantageously, Ng differentiated CSI feedback is achieved with such signaling.

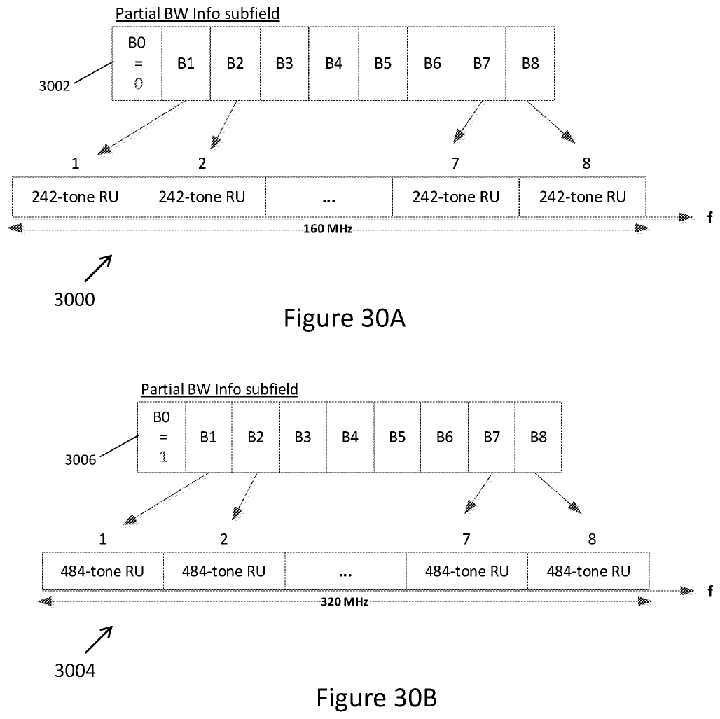

In an embodiment E3, the Partial BW Info subfield (in a Sensing NDPA frame and Sensing Measurement Report frame) may be configured to have full flexibility of indicating any combinations of RUs/MRUs within the operating bandwidth (and not restricted to the values currently defined in the EHT specification, as EHT specification only allows specific values of partial BW Info field). For example, referring to partial BW Info field 3000 of FIG. 30A when bit B0 3002 is set to ‘0’, each of the subsequent 8 bits that is set to 1 indicates whether CSI feedback is solicited from each of the 242-tone RU within the 160 MHz channel. If the operating bandwidth is narrower than 160 MHz (e.g., 80 MHz), only the first 4 bits (e.g., bits B1-B4 of partial BW Info field 3000) may be set to 1 and the rest of the bits are reserved. The bitmap may also be extended by another 8 bits, such that up to 320 MHz can be covered with granularity of 242-tones. Bits B9-B17 in partial BW Info field 3000 may indicate whether CSI feedback is solicited or not for each of the 242-tone RU. Further referring to partial BW Info field 3004 of FIG. 30B when bit B0 3008 is set to ‘1’, each of the subsequent 8 bits that is set to 1 indicates whether CSI feedback is solicited from each of the 484-tone RU within the 320 MHz channel.

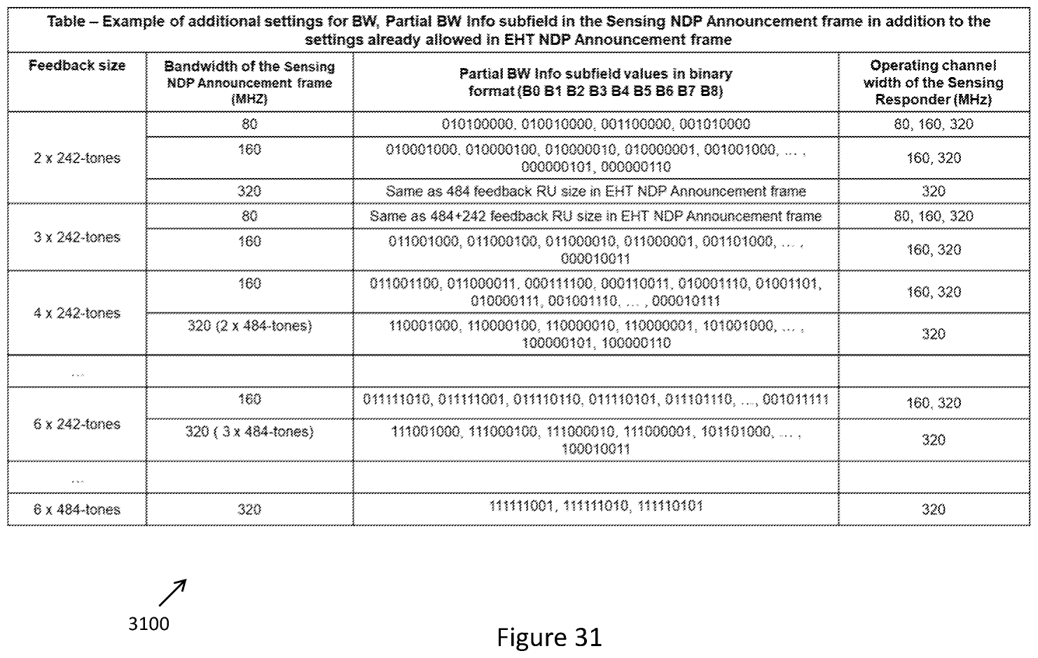

FIG. 31 shows a table 3100 describing additional settings for BW, Partial BW Info subfield in a sensing NDPA frame (assuming a 9-bit field) in addition to the settings already allowed in an EHT NDPA frame according to embodiment E3. Referring to Partial BW Info subfield values in binary format (B0 B1 B2 B3 B4 B5 B6 B7 B8) as shown in table 3100, for each bandwidth of the Sensing NDPA, only the Partial BW Info subfield values that are unique to that bandwidth (i.e., not already listed for a narrower bandwidth) are listed in the table. The proposed Partial BW Info values allows full flexibility in terms of selecting any combination of subchannels for feedback from within an operating channel bandwidth. As an example, if the Partial BW Info field is set as 010001000 and the operating channel bandwidth is 160 MHz, the Initiator STA is requesting feedback only for the 1^{st} and the 5^{th} 242-tone RUs.

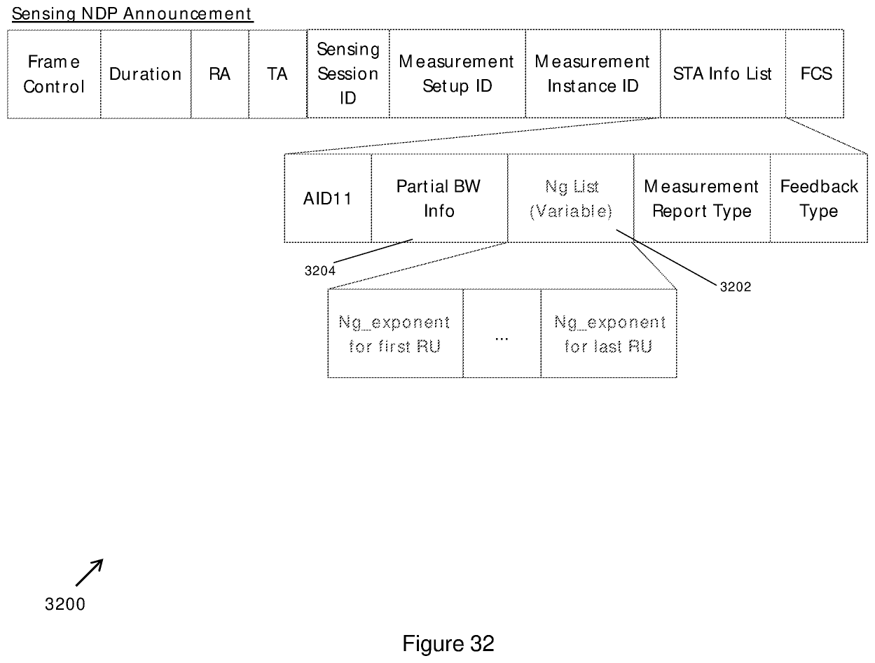

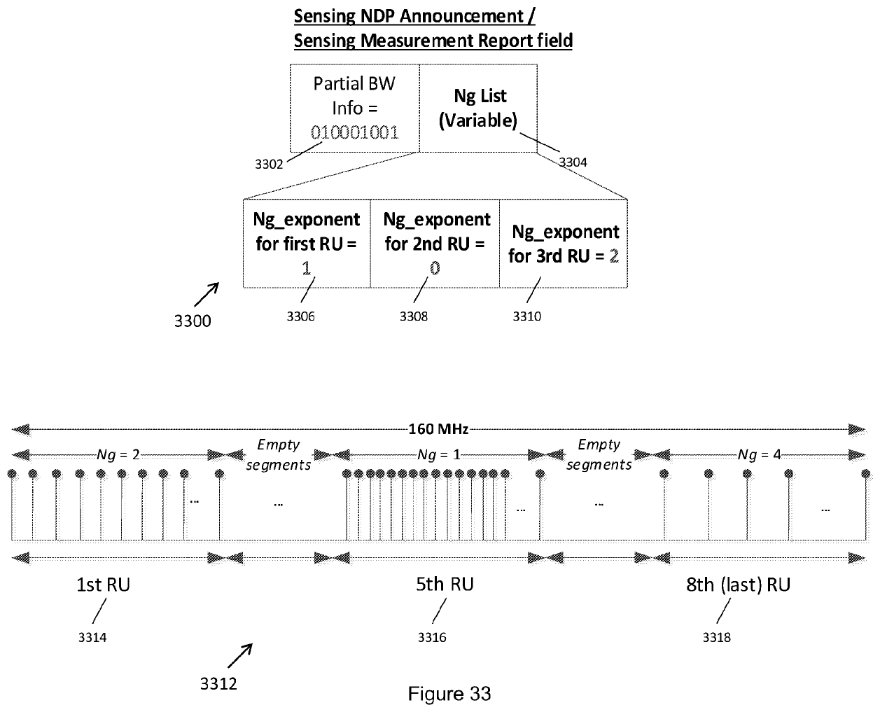

FIG. 32 depicts an example illustration of a Sensing NDPA frame 3200 according to embodiment E3. In this case the Partial BW Info field can flexibly signal any combination of subchannels (or segments) requested for feedback and the size of the segments is indicated by B0 of the Partial BW Info field (0 for 242-tone RU and 1 for 484-tone RU). Only the Ng_exponents are explicitly signaled in the Sensing NDPA frame 3200 (e.g., in Ng List subfield 3202) and corresponding Sensing Measurement Report frame, one Ng_exponent subfield being present for each segment requested for feedback. The number of segments and the corresponding number of Ng_exponent subfields are deduced from the Partial BW Info field 3204. Referring to an example of Ng differentiated CSI feedback based on the Partial BW Info subfield and the Ng List subfield 3300 of a Sensing NDPA frame or a Sensing Measurement Report frame and corresponding feedback process 3312 of FIG. 33 wherein Sensing bandwidth is 160 MHz, feedback segments are indicated by Partial BW Info field 3302 as “010001001” or three 242-tone RUs. Accordingly, 3 different Ng values (2, 1, 4) are indicated for the first, fifth and the eighth 242-tones RUs e.g., Ng_component for first RU is indicated as “1” in subfield 3306 of Ng List field 3304 for first RU 3314 so that Ng value is 2\hat{ }1=2, Ng_component for fifth RU is indicated as “0” in subfield 3308 of Ng List field 3304 for fifth RU 3316 so that Ng value is 2\hat{ }0=1, and Ng_component for fifth RU is indicated as “2” in subfield 3310 of Ng List field 3304 for eighth RU 3318 so that Ng value is 2\hat{ }2=4. Advantageously, Ng differentiated CSI feedback signaling is simpler.

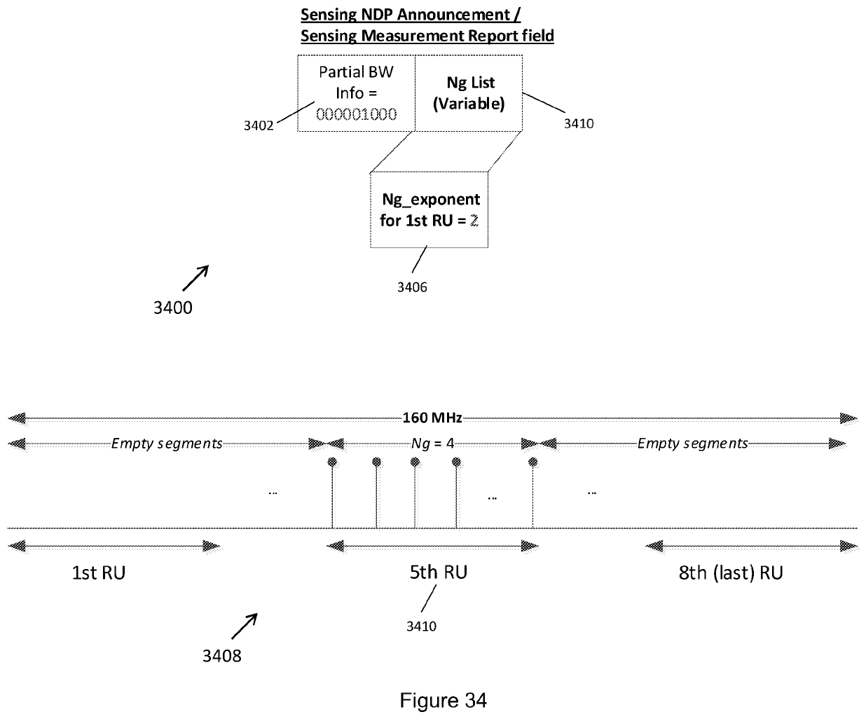

Referring to another example of Ng differentiated CSI feedback based on the Partial BW Info subfield and the Ng List subfield 3400 of a Sensing NDPA frame or a Sensing Measurement Report frame and corresponding feedback process 3408 of FIG. 34 wherein subcarriers of interest are limited to a single 242-tone RU segment and sensing NDPA bandwidth is 160 MHZ, feedback size is indicated by partial BW Info field 3402 as “000001000” or one 242-tone RU. Accordingly, a single Ng value (4) is indicated for the fifth 242-tones RUs e.g., Ng_component for fifth RU is indicated as “2” in subfield 3406 of Ng List field 3304 for fifth RU 3310 so that Ng value is 2\hat{ }2=4. Here, it is assumed that Ng value=4 is the smallest possible Ng value (defined in the 11 bf specification). In such case, the responder may also report the average CSI value for a group of subcarriers (e.g., group of 4 for Ng=4) to capture the channel information of the omitted subcarriers as well. Such requests for averaging operation for the CSI value of a groups of subcarriers may also be signaled by the initiator, e.g., in the Sensing NDPA frame.

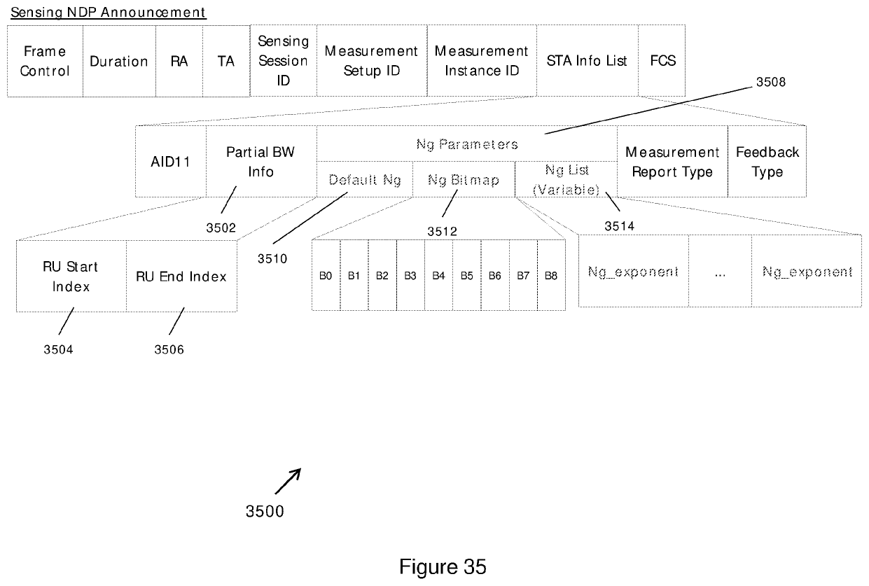

In an embodiment E4, when an HE NDP is used as measurement PPDU such as for example a Sensing NDP, the Partial BW Info subfield in a corresponding Sensing NDPA frame and Sensing Measurement Report frame is based on the HE format (e.g., indicating RU Start Index, RU End Index). FIG. 35 depicts an example illustration of a Sensing NDPA frame 3500 according to embodiment E4. RU Start Index subfield 3504 and RU End Index subfield 3506 of partial BW Info field 3502 indicate the first 26-tone RU and the last 26-tone RU for which an Initiator STA is requesting feedback respectively. The following Ng Parameters signaling (e.g., in Ng parameters field 3508) may be used for both Sensing NDPA and Sensing Measurement Report frames. Default Ng field 3510 may indicate the Ng value (using the same encoding as the Ng_exponent subfield) that is applied to all feedback RUs/MRUs except those covered by the subchannels indicated in Ng Bitmap subfield 3512. The encoding of the Ng Bitmap subfield 3512 may be the same as that of the Partial BW Info field 3204 described in embodiment E3, except that each of the 8 bits, aside from B0, that is set to 1 indicates that a Ng_exponent subfield exists in a corresponding Ng List subfield 3514, and that the Ng_exponent subfield carries a Ng value that is different from the default Ng value, for each of the 242-tone/484-tone RU within the 160/320 MHz channel. The Ng list subfield 3514 indicates the Ng values (as a list of Ng_exponent values) for the subchannels indicated by the Ng Bitmap subfield 3512. Although not shown in the figure, the NDPA frame 3500 may also include a STA Info List with the AID11 field set to 2047 in which case the Partial BW Info field in the STA Info List is replaced with a Disallowed Subchannel Bitmap, the lowest numbered bit of the Disallowed Subchannel Bitmap subfield corresponding to the 20 MHz subchannel that lies within the BSS bandwidth and that has the lowest frequency of the set of all 20 MHz subchannels within the BSS bandwidth. Each successive bit in the bitmap corresponds to the next higher frequency 20 MHz subchannel. A bit in the bitmap is set to 1 to indicate that for the corresponding 20 MHz subchannel, no energy is present in the HE Sounding NDP associated with this NDP Announcement frame and the corresponding bit in the Ng Bitmap subfield in all other STA Info lists are set to 0 to indicate that a Ng_exponent subfield does not exist for this subchannel. For each disallowed 20 MHz subchannel, the 242-tone RU that is most closely aligned in frequency with the 20 MHz subchannel is disallowed. STAs addressed by the NDP Announcement frame do not include tones (i.e., subcarriers) from disallowed 242-tone RUs when determining the average SNR of space time streams and when generating the requested sounding feedback. If a 20 MHz subchannel and its corresponding 242-tone RU is not disallowed, the corresponding bit in the disallowed subchannel bitmap is set to 0.

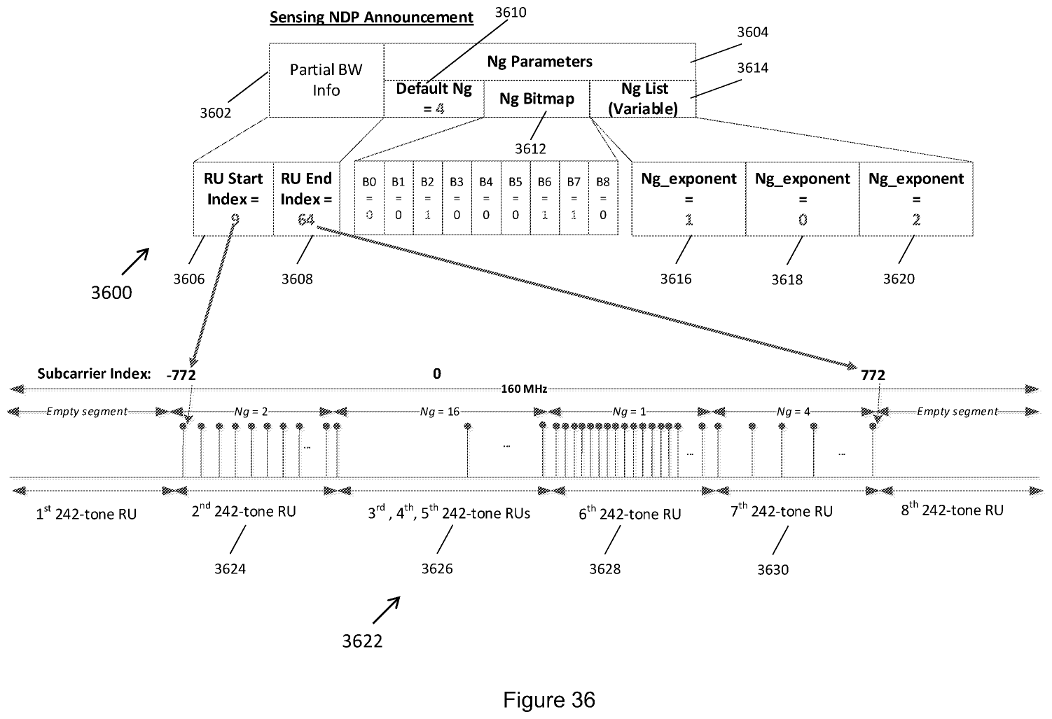

Referring to an example of Ng differentiated CSI feedback based on Sensing NDPA frame 3600 and corresponding feedback process 3622 of FIG. 36 wherein the sensing bandwidth is 160 MHZ. Feedback RUs are indicated by Partial BW Info field 3602 as the 10th 26-tone RU (indicated by a value “9” in RU start index subfield 3606 of partial BW Info field 3602) to 65th 26-tone RU (indicated by a value “64” in RU end index subfield 3608 of partial BW Info field 3602), or 2nd to 7th 242-tone RUs. The default Ng indicated in default Ng subfield is “4” which means that default Ng value is 2\hat{ }4=16. This Ng value applies to the 3rd, 4th and 5th 242-tone RUs 3626. B0 in Ng Bitmap field 3612 is set to 0 to indicate 20 MHz granularity, while B2, B6 and B7 are set to 1 to indicate that non-default Ng values are indicated in the Ng List subfields 3616, 3618 and 3620 corresponding to the 6th 242-tone RU 3628, the 2nd 242-tone RU 3624, and the 7th 242-tone RU 3630 respectively.

In this example, the 6th 242-tone RU 3628, the 2nd 242-tone RU 3624, and the 7th 242-tone RU 3630 are of special interest (in decreasing order) for the sensing application and hence the smaller values of Ng, while the 3rd to 5th 242-tone RUs 3626 are not of special interest (and hence large value of Ng). The subcarrier indices are based on Table 9-122 (Subcarrier indices scidx(0) and scidx(Ns−1) for Ng=4) in the 802.11ax-2021 specification corresponding to the 160 MHz column.

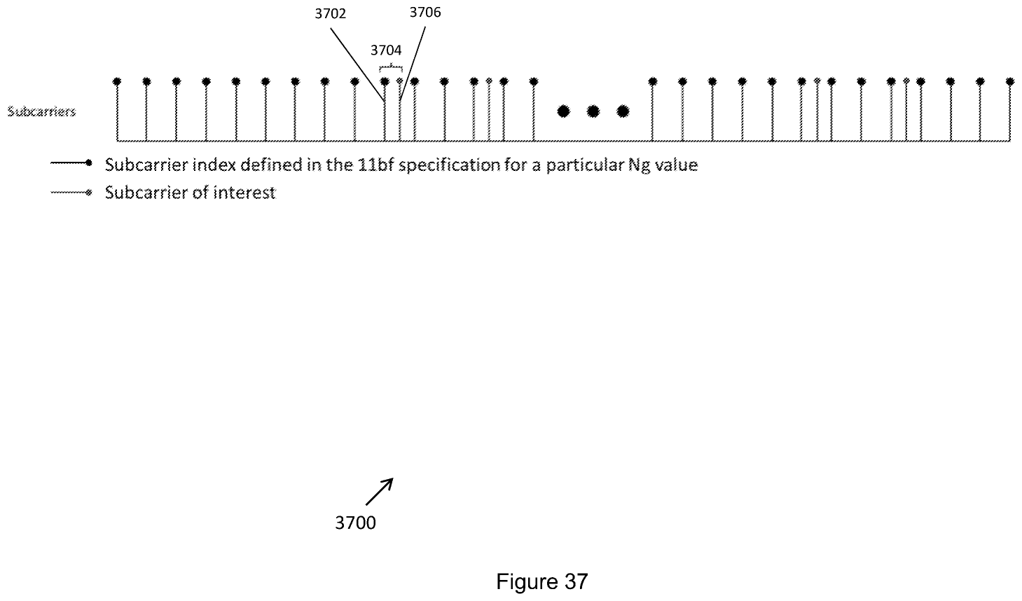

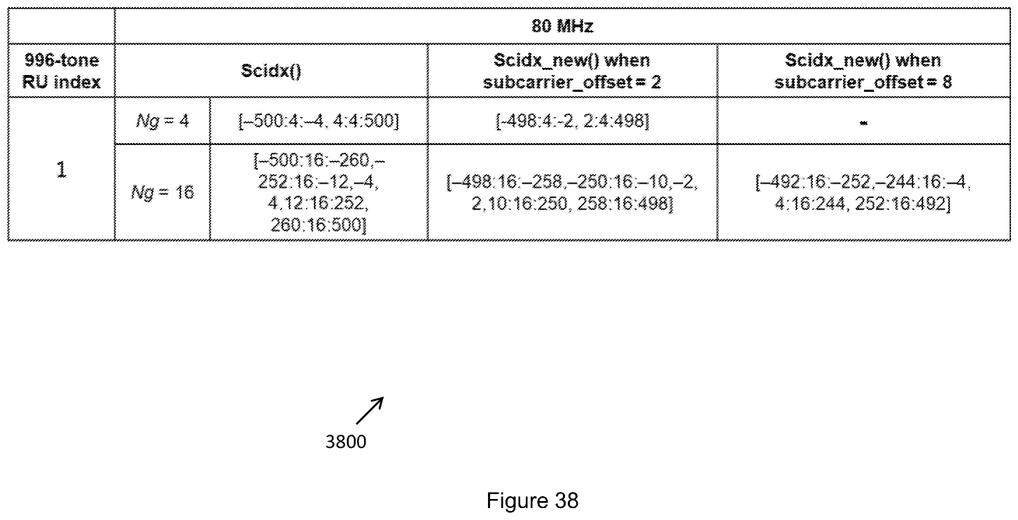

In an embodiment E5, an initiator may indicate, along with grouping parameter Ng, a “subcarrier_offset” which is a difference between an index of a defined subcarrier (e.g., as defined in the specs for a Ng value) and a subcarrier of interest. An example of this difference is shown in illustration 3700 of FIG. 37 as subcarrier offset 3704 between a defined subcarrier 3702 and a subcarrier of interest 3706. For i=0 to Ns−1, scidx_new(i)=scidx(i)+subcarrier_offset (herein referred to as Equation E5-1), wherein scidx( ) returns the predefined subcarrier indices (e.g., as defined in baseline or in table 1800 of FIGS. 18 and 1900 of FIG. 19) for a particular Ng value and Ns is the total number of reported subcarriers. The value of subcarrier_offset shall be less than the value of Ng. If Equation E5-1 returns a subcarrier index that is not within the valid index range (e.g., DC tones, or larger than the maximum index for that RU/MRU), scidx_new(i) returns the immediately preceding valid subcarrier index. This method may be used when the subcarriers of interest are uniformly distributed and follow the same pattern throughout the channel, e.g., are at the same distance from the defined subcarrier indices. An example table 3800 showing reported subcarriers for feedback on a 996-tone RU (in 80 MHz) for two values of subcarrier_offset (2, 8) is shown in FIG. 38. The entry for Scidx_new( ) when subcarrier_offset=8 and Ng=4 is empty since the offset value (8) is larger than the Ng value.

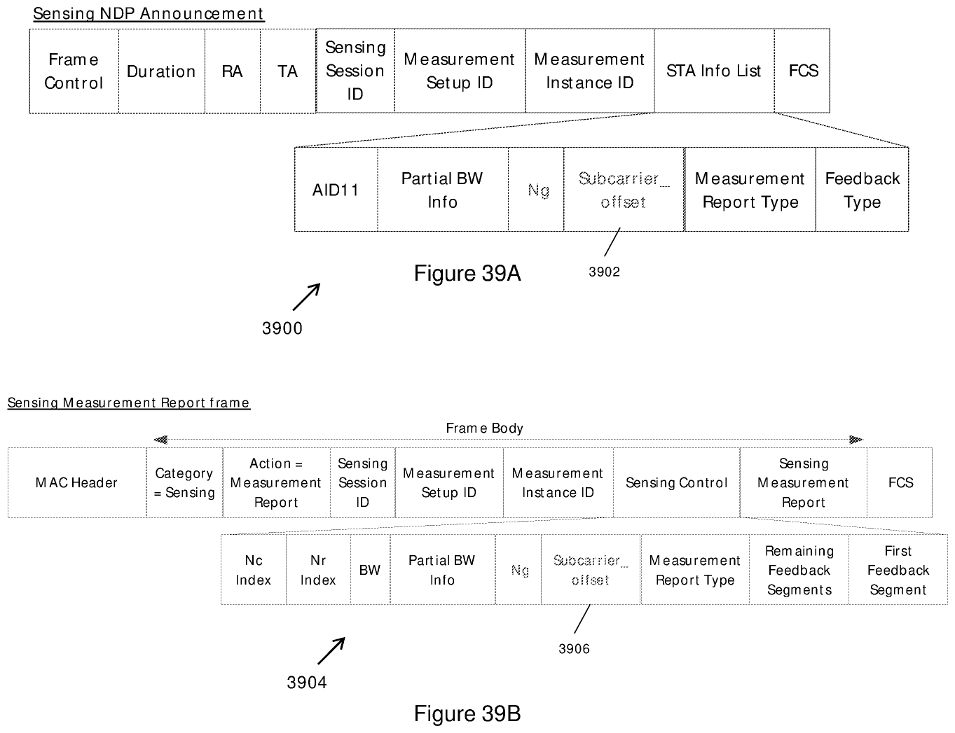

Referring to FIGS. 39A and 39B, the subcarrier_offset may be indicated in a subcarrier_offset field 3902 in a Sensing NDPA frame 3900 and a subcarrier_offset field 3906 in a Sensing Measurement Report frame 3904. An advantageous effect is that some flexibility in the choice of subcarriers can be achieved with minimal signaling overhead.

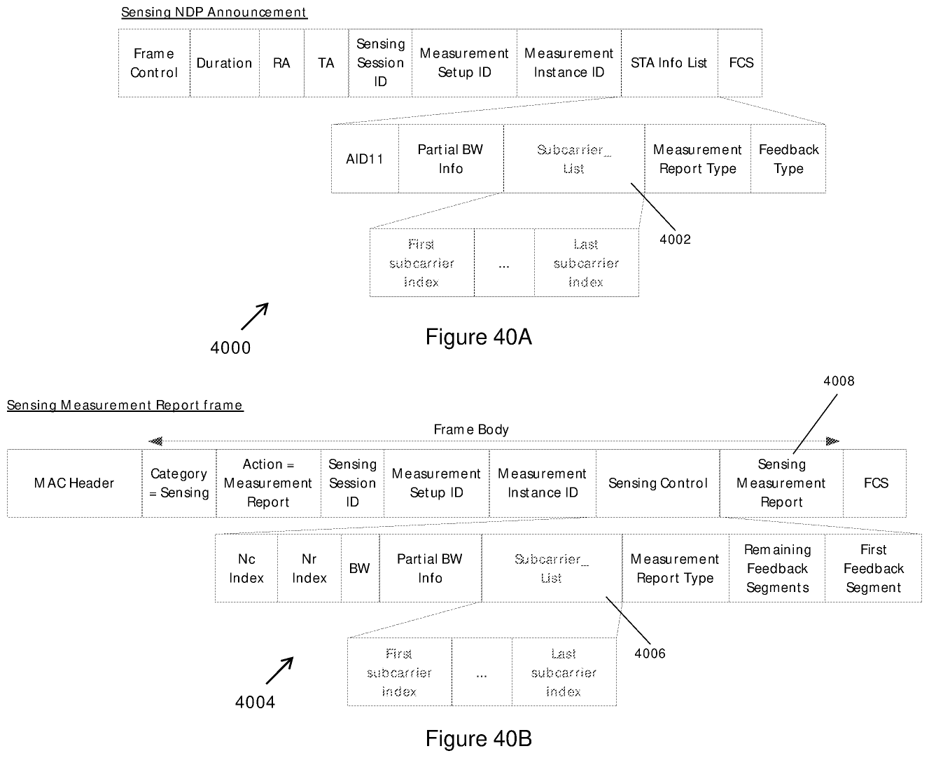

Alternatively, referring to FIGS. 40A and 40B, instead of indicating the subcarrier_offset value, the list of reported subcarrier indices may be indicated in Subcarrier_List field 4002 (comprising first to last subcarrier index subfields) in Sensing NDPA frame 4000 and Subcarrier_List field 4006 (comprising first to last subcarrier index subfields) in Sensing Measurement Report frame 4004, explicitly indicating the reported subcarrier (i.e., subcarriers for which CSI feedback is solicited/provided). Each of the first to last subcarrier index subfields may be 12 bits long and encoded as a 2s complement number (e.g. −2047, 2047). Further, feedback matrices may be included (e.g., in Sensing Measurement Report field 4008) only for the subcarrier indices included in the Subcarrier_List field 4006.

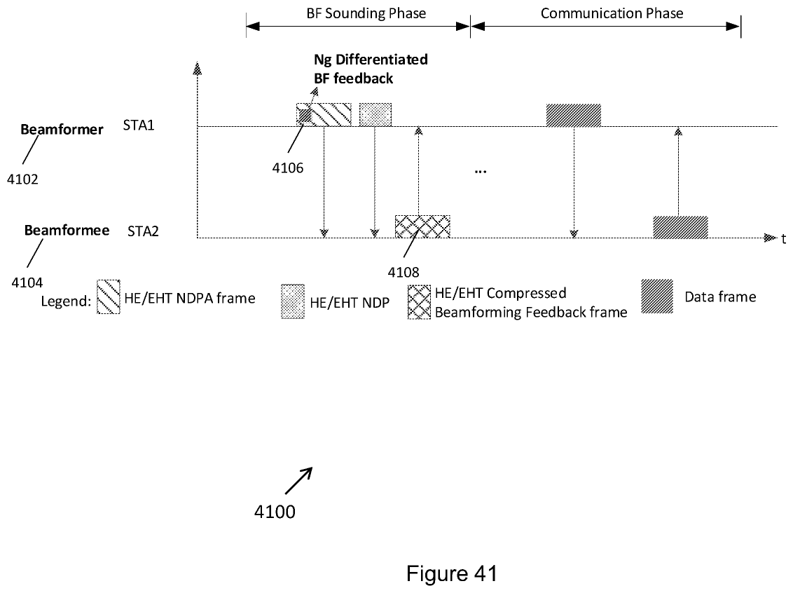

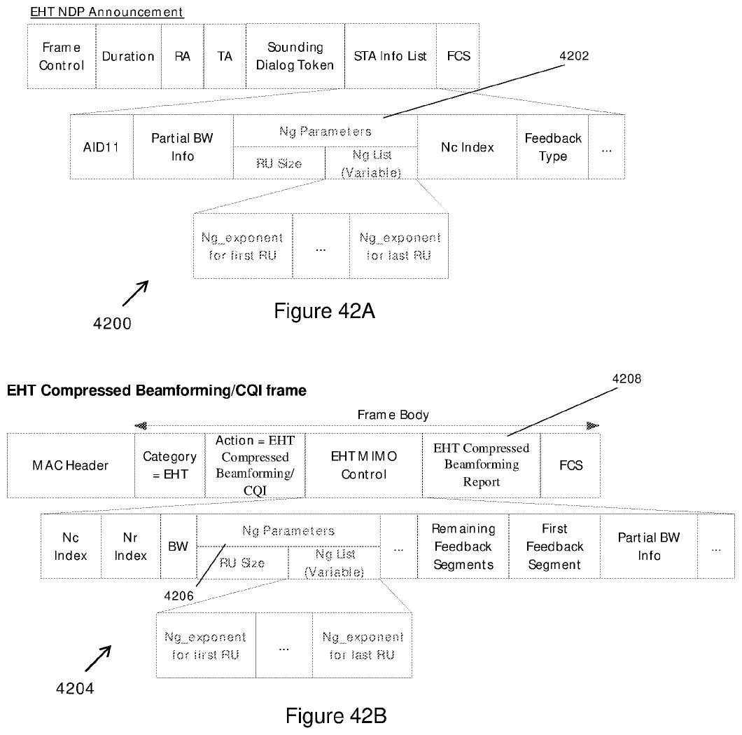

In an embodiment E6, Ng differentiated feedback may also be applied to Beamforming feedback, in this case it may be called Ng differentiated Beamforming (BF) feedback. Referring to illustration 4100 of FIG. 41 for example, Beamformer STA 4102 indicates different Ng values for different segments of the channel for which feedback is solicited (e.g. in HE/EHT NDPA frame 4106). In response, Beamformee STA 4104 includes the compressed beamforming feedback matrices for the reported subcarriers that are selected based on the different Ng values for the different segments of the channel for which feedback is solicited (e.g., in HE/EHT compressed beamforming feedback frame 4108). Embodiment E6 is specific for communication (i.e., non-sensing) use cases, and even though in FIG. 41 an example for HE/EHT STAs are shown, the Ng differentiated Beamforming may apply to any existing 802.11-based communication systems (11ac/11ax/11be/11ad/11ay etc.) that use channel sounding for transmit beamforming and/or MIMO including future 802.11 amendments. Referring to FIGS. 42A and 42B, again taking the example of HE/EHT STAs, HE/EHT NDPA frame 4200 and HE/EHT Compressed Beamforming/CQI frame 4204 may be modified to carry a Ng parameters subfield (e.g., Ng parameters subfield 4202 of HE/EHT NDPA frame 4200 and Ng parameters subfield 4206 of HE/EHT Compressed Beamforming/CQI frame 4204) which has the same encoding as described in embodiment E1. Furthermore, compressed beamforming feedback matrices may be included in EHT compressed beamforming report field 4208 of HE/EHT Compressed Beamforming/CQI frame 4204 for subcarrier indices that are selected using the Ng value for each channel segment.

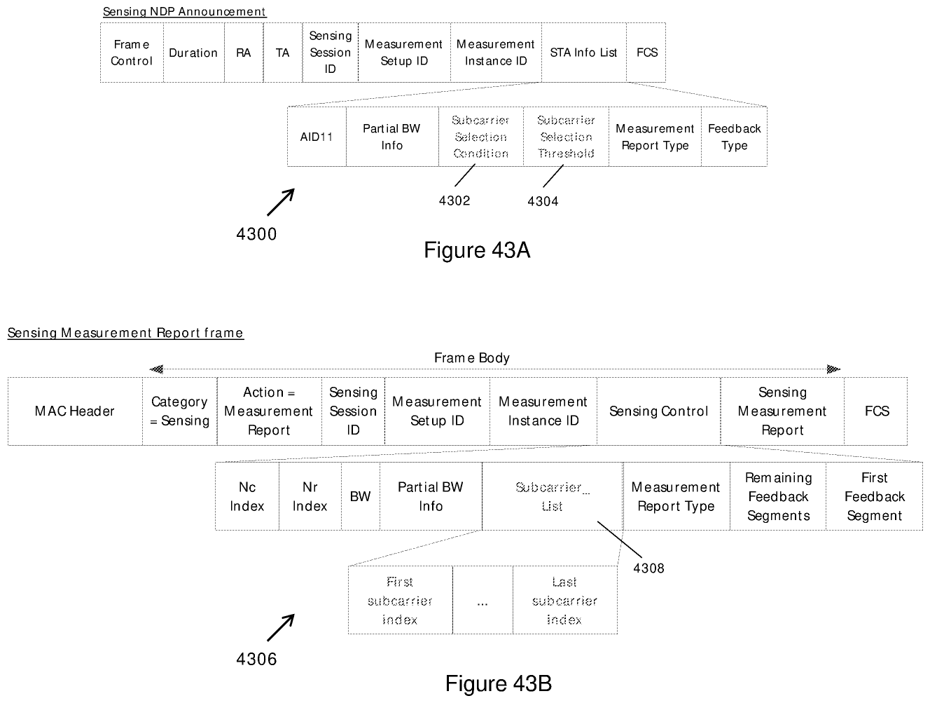

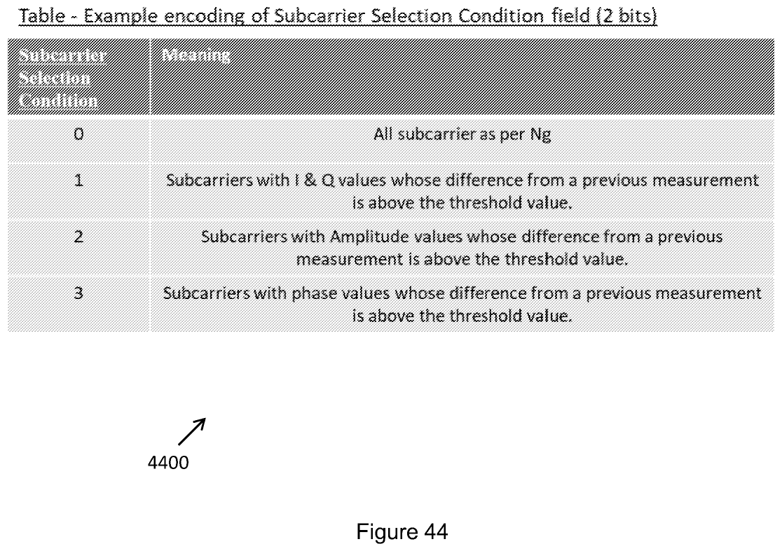

In an embodiment E7, instead of directly indicating subcarrier indices, an initiator may indicate a condition for choosing a subcarrier to be reported (e.g., subcarriers with CSI/Phase/Amplitude value difference from a previous measurement above a threshold value, and other similar values). For example, a selection condition may be indicated in a 2-bit subcarrier selection condition field 4302 in Sensing NDPA frame 4300 of FIG. 43A, based on the various values and corresponding meanings as shown in table 4400 of FIG. 44. For example, if subcarrier selection condition field 4302 indicates a value of 0, all subcarriers are selected based on grouping parameter Ng. If subcarrier selection condition field 4304 indicates a value of 1, subcarriers with I and Q values whose difference from a previous measurement is above a threshold value (for example, a threshold value as indicated in subcarrier selection threshold field 4304 of Sensing NDPA frame 4300) are selected. If subcarrier selection condition field 4302 indicates a value of 2, subcarriers with amplitude values whose difference from a previous measurement is above a threshold value (for example, a threshold value as indicated in subcarrier selection threshold field 4304 of sensing NDPA frame 4300) are selected. Further, if subcarrier selection condition field 4302 indicates a value of 3, subcarriers with phase values whose difference from a previous measurement is above a threshold value (for example, a threshold value as indicated in subcarrier selection threshold field 4304 of Sensing NDPA frame 4300) are selected. A responder may then perform subcarrier selection based on the indicated condition and only includes the selected subcarriers in a Sensing Measurement Report, for example as a list of subcarrier indices in a subcarrier_list field 4308 in Sensing Measurement Report frame 4306 of FIG. 43B. Alternatively, instead of the list of subcarrier indices, any of the above described signaling for embodiments E1-E5 may also be used by the responder to provide feedback for the selected subcarriers. The responder may also indicate the top 10 or top n subcarriers that matches the indicated condition (e.g., high variance). The value of ‘n’ may also be indicated by the initiator. The responder may also feedback just the result, such as a simple indication e.g., a variance that crossed a threshold for half the subcarriers, instead of providing CSI feedback. It is also possible that even for Ng differentiated feedback, the subcarrier selection condition and subcarrier selection threshold may also be provided such that different Ng values apply for different segments of the channel, and within a segment, from among the subcarriers selected based on the Ng value for that segment, the Responder STA perform further selection of subcarriers based on the provided subcarrier selection condition and subcarrier selection threshold.

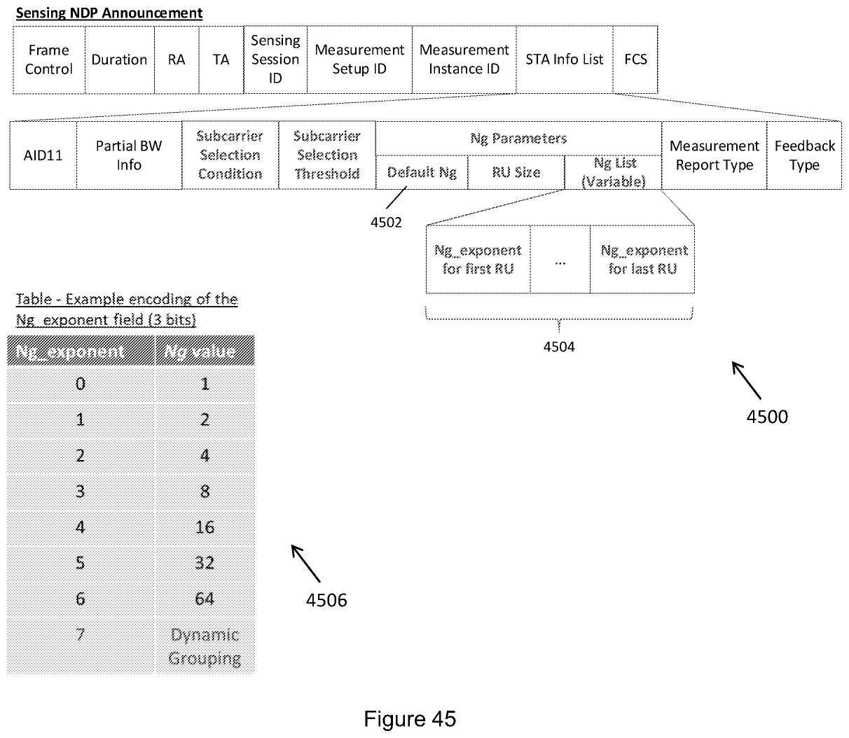

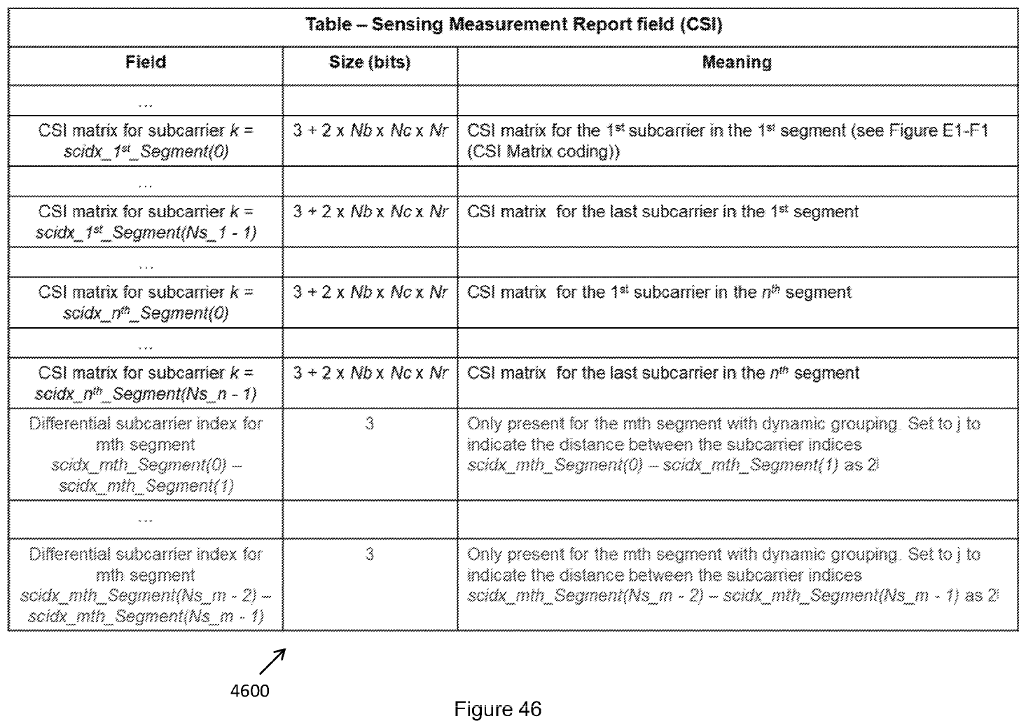

In an embodiment E7-1, a dynamic grouping of subcarriers is proposed for CSI feedback, wherein for a given fixed Ng value, additional signaling (Differential subcarrier index=j) is included in a Sensing Measurement Report such that 2^{j} indicates a distance between two adjacent reported subcarriers, with the conditions that DC subcarriers are not included, edge subcarriers are always included, and the distance is chosen such that the subcarrier indices correspond to the indices defined in the specification for the selected Ng value. Referring to Sensing NDPA frame 4500 of FIG. 45, Default Ng field 4502 may be configured to indicate the Ng value that applies in the segment with dynamic grouping. The Ng value determines the number of subcarriers that are reported in that segment. A value of Ng_exponent (e.g., a value of 7 as shown in table 4506) is reserved to indicate that dynamic grouping applies to the channel segment. The value of Ng_exponent for each segment is indicated in a corresponding field among the Ng_exponent fields 4504. Table 4600 of FIG. 46 describes a Sensing Measurement Report field for CSI feedback according to embodiment E7-1. The same signaling is also used in the Sensing Measurement Report frame to indicate dynamic grouping. For example, when the Sensing Measurement Report frame indicates dynamic grouping for the mth segment (by setting the Ng_exponent field to 7), a Differential subcarrier index field is included for every two adjacent reported subcarriers in the m-th segment, e.g., as scidx_mth_Segment(0)-scidx_mth_Segment(1) for the 1^{st} and 2^{nd} reported subcarriers etc., the size of the field is 3 bits. The indicated Differential subcarrier index is only present for the m-th segment with dynamic grouping, and set to j to indicate the distance between the subcarrier indices scidx_mth_Segment(0)-scidx_mth_Segment(1) as 2^{j}. For example, if the Differential subcarrier index for scidx_mth_Segment(0)-scidx_mth_Segment(1) indicates 3, the difference between the subcarrier indices of the 1^{st} reported subcarrier and the 2^{nd} reported subcarrier in the m^{th} segment is 8 (2³)

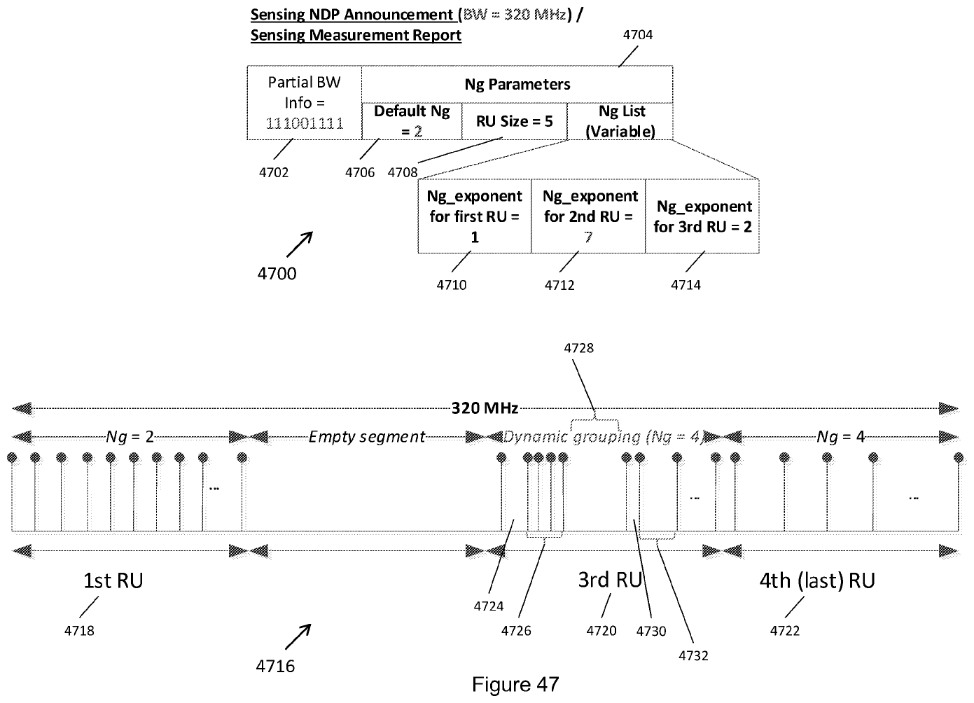

FIG. 47 depicts an example illustration of the Partial BW Info field and the Ng Parameter field 4700 in a Sensing NDPA frame or a Sensing Measurement Report frame for a sensing bandwidth of 320 MHz and the corresponding subcarriers for which feedback is reported 4716 according to embodiment E7-1. Feedback RU/MRU size is indicated by Partial BW Info field 4702 as “111001111” or three 996-tones RUs (1^{st}, 3^{rd} and 4^{th}). In Ng parameters field 4704, Default Ng field indicates a value of “2” which in turn indicates that Ng=4 for segments with dynamic grouping. RU size field 4706 indicates a value of “5” (996 tones). For example, the 3*996 feedback MRU is sub-divided into 3 segments, each segment being a 996-tones (subcarriers) RU. Ng values (2, 4) are indicated for 1^{st} and 4th 996-tones RUs 4718 and 4722 (e.g., indicated in Ng list subfields 4710 and 4714 for the 1^{st} and the 4^{th} 996-tones RUs 4718 and 4722 respectively) while dynamic grouping is indicated for the 3^{rd} 996-tones RU 4720 as a Ng value “7” in Ng list subfield 4712. Dynamic grouping can be seen in the 3^{rd} 996-tones RU 4720, in which the number of reported subcarriers is determined using the default Ng=4 and there are varying Differential subcarrier indices of values “2” (i.e., difference between the subcarrier indices=4 for differential subcarrier index 4724), “0” (i.e., difference between the subcarrier indices=1 for differential subcarrier indices 4726 and 4730), “5” (i.e., difference between the subcarrier indices=32 for differential subcarrier index 4728), and “4” (i.e., difference between the subcarrier indices=16 for differential subcarrier index 4732).

Thus, subcarrier selective channel information feedback and related signaling can be utilized as described in the various embodiments. For example, a single feedback may be sent for a group of Ng subcarriers in which the value of Ng can be different for different segments of the channel, as shown in embodiments E1, E2, E3 and E4. Indices of the subcarriers for which feedback is sent may be implicitly signaled as an offset or explicitly signaled, as shown in embodiment E5. Further, default and non-default Ng values may be indicated as shown in embodiment E4, conditions for selecting subcarriers may be indicated as shown in embodiment E7, and dynamic grouping of subcarriers for feedback may also be indicated in embodiment E7-1.

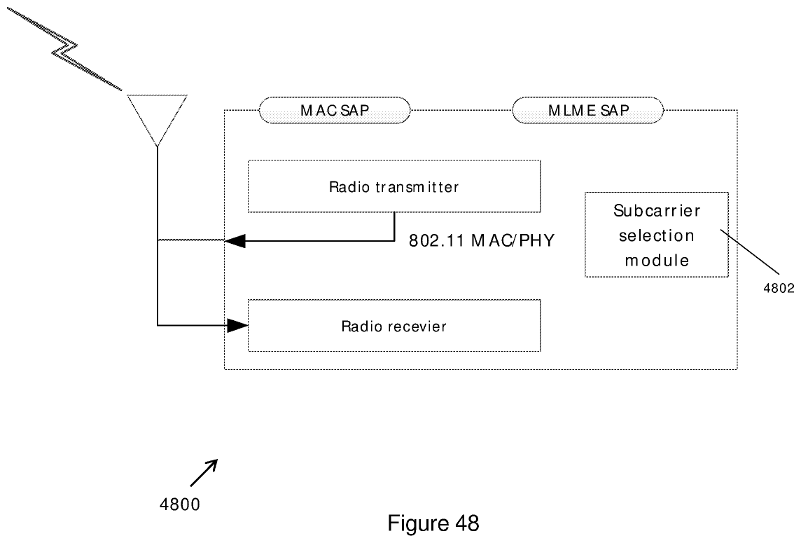

FIG. 48 depicts a schematic diagram for an apparatus 4800 suitable for sensing and communication in accordance with various embodiments. The apparatus 4800 may be configured to perform communication utilizing subcarrier selective feedback and may comprise a subcarrier selection module 4802 configured for performing functions required for such communication. The subcarrier selection module 4802 may be configured to measure channel information feedback of a channel based on a PPDU, wherein the channel to be measured is sub-divided into two or more segments and each of the two or more segments comprises one or more subcarriers, and select a subset of one or more subcarriers to be reported for the corresponding segment based on a grouping parameter Ng. The subcarrier selection module 4802 may have an inbuilt memory of its own that may be used to store the PPDU formats and relevant information for performing subcarrier selection, such that subcarrier selection can be performed by the apparatus 4800 without any indication from or involvement of, for example, another communication apparatus.

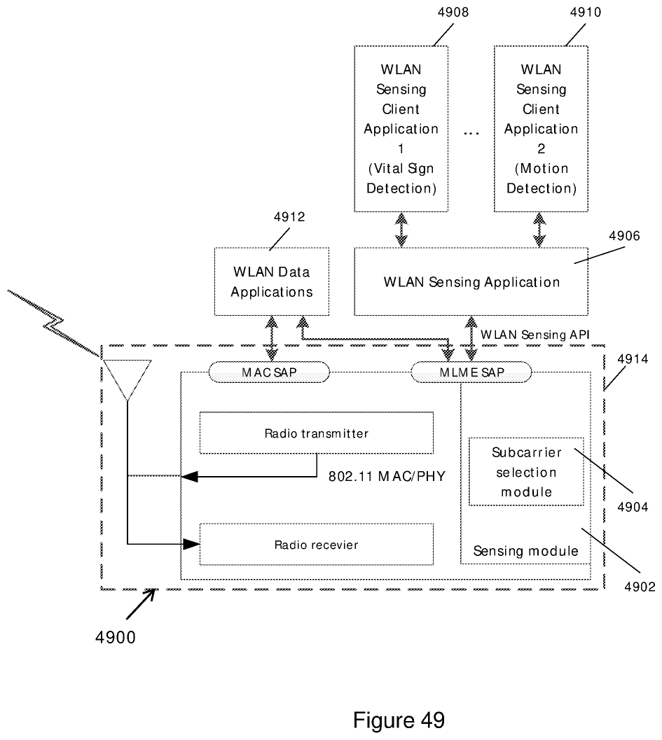

FIG. 49 depicts a schematic diagram for a sensing apparatus 4900 (shown within the dotted line portion 4914) in accordance with various embodiments. The sensing apparatus 4900 may be configured to communicate with another communication apparatus for sensing measurements and may comprise a sensing module 4902 that may be configured for performing functions required for such sensing measurements, including utilizing subcarrier selective feedback. The sensing module 4902 may further comprise subcarrier selection module 4904 configured for performing functions required for subcarrier selective feedback. The subcarrier selection module 4904 may be configured to measure channel information feedback of a channel based on a PPDU, wherein the channel to be measured is sub-divided into two or more segments and each of the two or more segments comprises one or more subcarriers, and select a subset of one or more subcarriers to be reported for the corresponding segment based on a grouping parameter Ng. The subcarrier selection module 4904 may have an inbuilt memory of its own that may be used to store the PPDU formats and relevant information for performing subcarrier selection, such that subcarrier selection can be performed by the apparatus 4900 without any indication from or involvement of, for example, the another communication apparatus. The sensing apparatus 4900 may further interact with a WLAN sensing application module 4906 via a WLAN Sensing API. The WLAN sensing application module 4906 may further interact with a WLAN sensing application module 4908 for performing functions relating to vital sign detection, and a WLAN sensing application module 4910 for performing functions relating to motion detection. The sensing apparatus 4900 may also concurrently act as a communication apparatus and interact with one or more WLAN Data applications 4912.

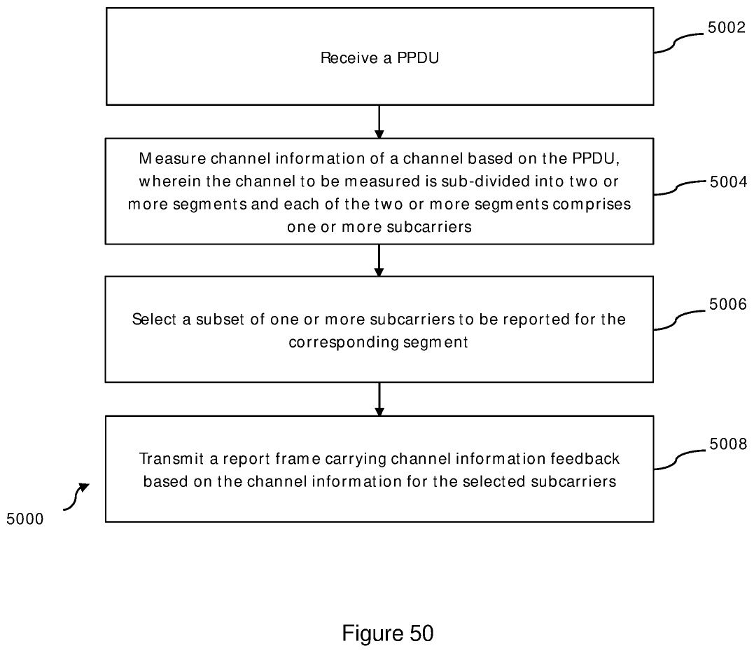

FIG. 50 shows a flow diagram 5000 illustrating a communication method according to various embodiments. At step 5002, a PPDU is received. At step 5004, channel information of a channel is measured based on the PPDU, wherein the channel to be measured is sub-divided into two or more segments and each of the two or more segments comprises one or more subcarriers. At step 5006, a subset of one or more subcarriers to be reported for the corresponding segment is selected. At step 5008, a report frame is transmitted, the report frame carrying channel information feedback based on the channel information for the selected subcarriers.

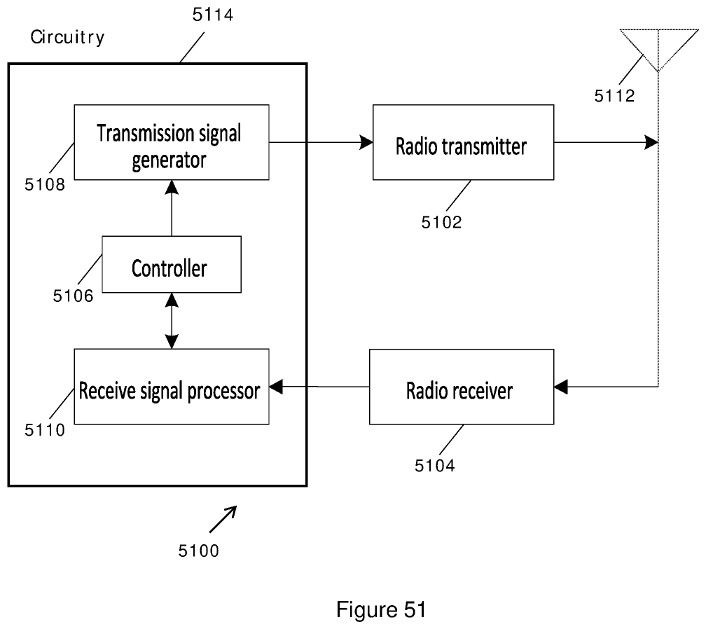

FIG. 51 shows a schematic, partially sectioned view of a communication apparatus 5100 that can be implemented for subcarrier selective feedback in accordance with the embodiments E1-E7.1. The communication apparatus 5100 may be implemented as an STA or AP according to various embodiments.

Various functions and operations of the communication apparatus 5100 are arranged into layers in accordance with a hierarchical model. In the model, lower layers report to higher layers and receive instructions therefrom in accordance with IEEE specifications. For the sake of simplicity, details of the hierarchical model are not discussed in the present disclosure.

As shown in FIG. 51, the communication apparatus 5100 may include circuitry 5114, at least one radio transmitter 5102, at least one radio receiver 5104 and multiple antennas 5112 (for the sake of simplicity, only one antenna is depicted in FIG. 51 for illustration purposes). The circuitry may include at least one controller 5106 for use in software and hardware aided execution of tasks it is designed to perform, including control of communications with one or more other devices in a wireless network. The at least one controller 5106 may control at least one transmission signal generator 5108 for generating frames to be sent through the at least one radio transmitter 5102 to one or more other STAs or APs and at least one receive signal processor 5110 for processing frames received through the at least one radio receiver 5104 from the one or more other STAs or APs. The at least one transmission signal generator 5108 and the at least one receive signal processor 5110 may be stand-alone modules of the communication apparatus 5100 that communicate with the at least one controller 5106 for the above-mentioned functions. Alternatively, the at least one transmission signal generator 5108 and the at least one receive signal processor 5110 may be included in the at least one controller 5106. It is appreciable to those skilled in the art that the arrangement of these functional modules is flexible and may vary depending on the practical needs and/or requirements. The data processing, storage and other relevant control apparatus can be provided on an appropriate circuit board and/or in chipsets.

In various embodiments, when in operation, the at least one radio transmitter 3302, at least one radio receiver 5104, and at least one antenna 5112 may be controlled by the at least one controller 5106. Furthermore, while only one radio transmitter 5102 is shown, it will be appreciated that there can be more than one of such transmitters.

In various embodiments, when in operation, the at least one radio receiver 5104, together with the at least one receive signal processor 5110, forms a receiver of the communication apparatus 5100. The receiver of the communication apparatus 5100, when in operation, provides functions required for subcarrier selective feedback. While only one radio receiver 5104 is shown, it will be appreciated that there can be more than one of such receivers.

The communication apparatus 5100, when in operation, provides functions required for subcarrier selective feedback. For example, the communication apparatus 5100 may be a first communication apparatus. The receiver 5104 may, in operation, receive a PPDU. The circuitry 5114 may, in operation, measure channel information of a channel based on the PPDU, wherein the channel to be measured is sub-divided into two or more segments and each of the two or more segments comprises one or more subcarriers, and select a subset of one or more subcarriers to be reported for the corresponding segment. The transmitter 5102 may, in operation, transmit a report frame carrying channel information feedback based on the channel information for the selected subcarriers to a second communication apparatus.

The channel information feedback may be one of CSI feedback, noncompressed beamforming feedback, or compressed beamforming feedback. The transmitter 5102 may be further configured to transmit one or more different report frames, wherein the channel information feedback for different segments are included in the one or more different report frames, or within different fields or information elements within a same report frame. The circuitry 5114 may be further configured to select a subset of subcarriers, wherein the selected subset of subcarriers are implicitly indicated in the report frame by an offset value of a known subcarrier. The circuitry 5114 may be further configured to select a subset of subcarriers, wherein the selected subset of subcarriers are explicitly indicated in the report frame by indices of the selected subset of subcarriers.

The subcarriers to be reported for each segment may be based on a grouping parameter Ng. The report frame may indicate a size of each segment and a value of the grouping parameter Ng for each segment, and may include a feedback matrix for the subcarriers selected based on the grouping parameter Ng. The circuitry 5114 may be further configured to select one or more segments, wherein different grouping parameters Ng are indicated in the report frame for the selected segments, and a default grouping parameter Ng applies for the rest of the segments. The receiver 5104 may be further configured to receive a frame prior to reception of the PPDU, wherein a size of each segment and a value of the grouping parameter Ng to be used for each segment are indicated in the frame.

The circuitry 5114 may be further configured to select the subset of subcarriers based on a selection condition, the selection condition being a comparison of changes in I and Q value, changes in amplitude value, or changes in phase value of each subcarrier with a threshold value. The selection condition may be specified in a frame received prior to reception of the PPDU. Positions of the selected subcarriers may be indicated in the report frame, the indication being based on a difference between indices of two adjacent selected subcarriers.

Further, the communication apparatus 5100 may be a second communication apparatus. The transmitter 5102 may, in operation, transmit a PPDU that is used to measure channel information of a channel by the first communication apparatus, wherein the channel to be measured is sub-divided into two or more segments and each of the two or more segments comprises one or more subcarriers, and wherein a subset of subcarriers to be reported for the corresponding segment is selected based on a grouping parameter Ng. The receiver 5104 may, in operation, receive a report frame from the first communication apparatus, the report frame carrying channel information feedback based on the channel information for the selected subcarriers.

The transmitter 5102 may be further configured to transmit a frame prior to transmission of the PPDU, wherein a size of each segment and a value of the grouping parameter Ng to be used for each segment are indicated in the frame. The transmitter 5102 may be further configured to transmit a frame prior to transmission of the PPDU, wherein the conditions to be used by the first communication apparatus to select the subset of subcarriers is indicated in the frame. The frame may be a Null Data PPDU Announcement (NDPA) frame, the NDPA frame carrying a plurality of STA Info fields addressed to the first communication apparatus and a value of the grouping parameter Ng for each segment is indicated in a respective STA Info field of the plurality of STA Info fields.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra-LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred as a communication device.

Some non-limiting examples of such communication device include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication device is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication device may comprise an apparatus such as a controller or a sensor which is coupled to a communication apparatus performing a function of communication described in the present disclosure. For example, the communication device may comprise a controller or a sensor that generates control signals or data signals which are used by a communication apparatus performing a communication function of the communication device.

The communication device also may include an infrastructure facility, such as a base station, an access point, and any other apparatus, device or system that communicates with or controls apparatuses such as those in the above non-limiting examples.

A non-limiting example of a station may be one included in a first plurality of stations affiliated with a multi-link station logical entity (i.e. such as an MLD), wherein as a part of the first plurality of stations affiliated with the multi-link station logical entity, stations of the first plurality of stations share a common medium access control (MAC) data service interface to an upper layer, wherein the common MAC data service interface is associated with a common MAC address or a Traffic Identifier (TID).

Thus, it can be seen that the present embodiments provide communication devices and methods for subcarrier selective feedback.

While exemplary embodiments have been presented in the foregoing detailed description of the present embodiments, it should be appreciated that a vast number of variations exist. It should further be appreciated that the exemplary embodiments are examples, and are not intended to limit the scope, applicability, operation, or configuration of this disclosure in any way. Rather, the foregoing detailed description will provide those skilled in the art with a convenient road map for implementing exemplary embodiments, it being understood that various changes may be made in the function and arrangement of steps and method of operation described in the exemplary embodiments and modules and structures of devices described in the exemplary embodiments without departing from the scope of the subject matter as set forth in the appended claims.

1.-17. (canceled)

18. A first communication apparatus, comprising:
a receiver, which, in operation, receives a Null Data Physical Protocol Data Unit (NDP) Announcement frame and a NDP from a second communication apparatus;
circuitry, which, in operation, perform sensing measurement; and
a transmitter, which, in operation, transmits a sensing measurement report frame to the second communication apparatus wherein the sensing measurement report frame includes sensing measurement result information according to a subcarrier grouping parameter (Ng) which is set based on bandwidth information.

19. The first communication apparatus according to claim 18,
wherein a range of the Ng is set based on whether the bandwidth information of the NDP is wider than a determined value or not.

20. The first communication apparatus according to claim 18,
wherein the circuitry selects subcarriers for the sensing measurement based on a combination of the Ng and the bandwidth information notified by the second communication apparatus.

21. The first communication apparatus according to claim 18,
wherein the circuitry selects an empty segment in a frequency domain wherein the sensing measurement report frame does not contain a result of the sensing measurement corresponding to the selected empty segment.

22. The first communication apparatus according to claim 21,
wherein the circuitry selects the empty segment based on puncturing information notified by the second communication apparatus.

23. The first communication apparatus according to claim 22,
wherein the puncturing information is indicated by a bitmap field.

24. A communication method for a first communication apparatus, the communication method comprising:
receiving a Null Data Physical Protocol Data Unit (NDP) Announcement frame and a NDP from a second communication apparatus;
performing sensing measurement; and
transmitting a sensing measurement report frame to the second communication apparatus wherein the measurement report frame includes sensing measurement result information according to a subcarrier grouping parameter (Ng) which is set based on bandwidth information.

25. The communication method according to claim 24,
wherein a range of the Ng is set based on whether the bandwidth information of the NDP is wider than a determined value or not.

26. The communication method according to claim 24,
wherein subcarriers for the sensing measurement is set based on a combination of the Ng and the bandwidth information notified by the second communication apparatus.

27. The communication method according to claim 24, comprising:
selecting an empty segment in a frequency domain wherein the sensing measurement report frame does not contain a result of the sensing measurement corresponding to the selected empty segment.

28. The communication method according to claim 27,
wherein the empty segment is selected based on puncturing information notified by the second communication apparatus.

29. The communication method according to claim 28,
wherein the puncturing information is indicated by a bitmap field.
